(19) United States
(12) Patent Application Publication
(10) Pub. No.: US 2025/0305075 A1
(43) Pub. Date: Oct. 2, 2025

(54) EXTRACTION OF ELEMENTS AND/OR COMPOUNDS FROM IRON-CONTAINING MATERIALS SUCH AS IRON-CONTAINING TAILINGS, RECOVERY OF MAGNETICALLY SUSCEPTIBLE MATERIALS, AND RELATED SYSTEMS AND PRODUCTS

(71) Applicant: Phoenix Tailings, Inc., Woburn, MA (US)

(72) Inventors: Thomas Anthony Villalon, JR., Boston, MA (US); Michelle Ling Chao, Everett, MA (US); Elizabeth N. Cline, Somerville, MA (US); Alex Nyarko, Aurora, CO (US); Henry Chase Hutcheson, Malden, MA (US); Ryan Roberts McKeown, Somerville, MA (US); Rita Marie Silbernagel, Cambridge, MA (US)

(73) Assignee: Phoenix Tailings, Inc., Woburn, MA (US)

(21) Appl. No.: 18/865,323

(22) PCT Filed: May 12, 2023
(86) PCT No.: PCT/US2023/066957

§ 371 Date: Nov. 12, 2024

Related U.S. Application Data
(60) Provisional application No. 63/342,003, filed on May 13, 2022.
(60) Provisional application No. 63/405,077, filed on Sep. 9, 2022.

(51) Int. Cl. C21B 13/14; C21B 13/00; C22B 3/02; C22B 3/04; C22B 3/22; C22B 3/26; C22B 59/00

(52) U.S. Cl. CPC C21B 13/146; C21B 13/0073; C22B 3/02; C22B 3/04; C22B 3/22; C22B 3/26; C22B 59/00

(57) ABSTRACT

Extraction of elements and/or compounds from iron-containing materials, such as iron-containing tailings, and related systems and products are generally described. The systems and methods described herein can provide, in accordance with certain embodiments, the ability to efficiently process iron-containing (e.g., iron-rich) tailings even in the presence of aluminosilicates and/or other impurities. In addition, in accordance with some embodiments, the systems and methods described herein can provide the ability to efficiently extract different minerals and/or other compounds (e.g., metal(s), salt(s), etc.) from complex tailings structures. Furthermore, reactors and methods for recovery of a reaction product with a relatively high magnetic susceptibility are generally described. Certain reactors are configured such that, during operation, the reaction products are selectively transported to the magnetic field source, relative to the reactants.

### RELATED APPLICATIONS

This application claims priority under 35 U.S.C. § 119(e) to U.S. Provisional Patent Application No. 63/342,003, filed May 13, 2022, and entitled “Extraction of Elements and/or Compounds from Iron-Containing Materials such as Iron-Containing Tailings and Related Systems and Products,” and U.S. Provisional Patent Application No. 63/405,077, filed Sep. 9, 2022, and entitled, “Reactors and Methods for Recovery of Magnetically Susceptible Materials,” each of which is incorporated herein by reference in its entirety for all purposes.

### TECHNICAL FIELD

Extraction of elements and/or compounds from iron-containing materials, such as iron-containing tailings, recovery of magnetically susceptible materials, and related systems and products are generally described. cl SUMMARY

The present disclosure is related to extraction of elements and/or compounds (e.g., minerals or other compounds) from iron-containing materials, such as iron-containing tailings, and related systems and products. The present disclosure is directed to reactors and methods for recovery of a reaction product with a relatively high magnetic susceptibility. Certain aspects are related to the recovery from a vessel of a product of a chemical reaction with a magnetic susceptibility higher than that of a reactant (or all reactants) of the chemical reaction. The subject matter of the present disclosure involves, in some cases, interrelated products, alternative solutions to a particular problem, and/or a plurality of different uses of one or more systems and/or articles.

Certain aspects are directed to methods for extracting iron from an iron-containing material.

In some embodiments, the method comprises leaching the iron-containing material to produce solids comprising an iron-containing compound and a leachate comprising dissolved aluminosilicate and/or other impurities; and reducing the iron-containing compound to metallic iron.

In some embodiments, the method comprises leaching the iron-containing material to produce solids comprising hematite and/or goethite and a leachate comprising dissolved aluminosilicate and/or other impurities; reducing the solids such that a magnetite-rich stream is produced; and subjecting the magnetite-rich stream to magnetic separation such that a stream that is further enriched in magnetite compared to the magnetite-rich stream is produced.

Certain aspects are directed to systems.

In some embodiments, the system comprises a leaching unit comprising a first reactor, wherein the first reactor comprises a first vessel configured such that, during operation, an iron-containing material within the first vessel is leached to produce solids comprising an iron-containing compound and a leachate comprising dissolved aluminosilicate and/or other impurities; a solid-liquid separator fluidically connected to an outlet of the first reactor, wherein the solid-liquid separator is configured to separate the solids from the leachate; and an iron reduction unit comprising a second reactor, wherein the second reactor is fluidically connected to an outlet of the solid-liquid separator and comprising a second vessel, wherein the second vessel is configured to reduce the iron-containing compound in the solids to a magnetically susceptible iron-containing material.

In some embodiments, the system comprises a leaching unit comprising a first reactor, wherein the first reactor comprising a first vessel configured such that, during operation, an iron-containing material within the first vessel is leached to produce solids comprising an iron-containing compound and a leachate comprising dissolved aluminosilicate and/or other impurities; and a magnetic separation unit comprising a second reactor, wherein the second reactor comprises a second vessel configured such that, during operation, the iron-containing compound in the solids is selectively reduced to a magnetically susceptible iron-containing material and subjected to magnetic separation.

Certain aspects are related to reactors.

In some embodiments, the reactor comprises a vessel; a magnetic field source at least partially within the vessel; and a mixer at least partially within the vessel; wherein the reactor is configured such that, during operation, the reaction products are selectively transported to the magnetic field source, relative to the reactants.

Certain aspects are related to methods.

In some embodiments, the method comprises: carrying out, in a vessel, a chemical reaction in which a product of the chemical reaction has a greater magnetic susceptibility than a reactant of the chemical reaction; and simultaneously effecting, in the vessel, a separation between the product and the reactant with a magnetic field source.

Other advantages and novel features of the present disclosure will become apparent from the following detailed description of various non-limiting embodiments of the disclosure when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present disclosure will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIGS. 1A-1D are schematic illustrations of a system for processing iron-containing materials, according to certain embodiments. FIG. 1A is a schematic illustration of a system for extracting iron from iron-containing materials in the form metallic iron; FIG. 1B is a schematic illustration of a system for producing iron oxide based pigments from residual iron-containing materials produced from the process illustrated in FIG. 1A; FIG. 1C is a schematic illustration of a system for extracting rare earth metals from a leachate produced from the process illustrated in FIG. 1A; and FIG. 1D is a schematic illustration of a system for separating at least a portion of the extracted rare earth metals from FIG. 1C into light earth metals from heavy earth metals, according to some embodiments.

FIG. 2 is, in accordance with certain embodiments, a flow diagram illustrating a method for extracting iron from an iron-containing material, according to certain embodiments.

FIGS. 3A-3B are cross-sectional schematic illustrations of reactors configured for recovery of a reaction product with a relatively high magnetic susceptibility, according to certain embodiments.

FIG. 3C is a perspective view schematic illustration of a portion of a reactor configured for recovery of a reaction product with a relatively high magnetic susceptibility, according to certain embodiments.

FIG. 3D is a cross-sectional schematic illustration of a portion of a reactor configured for recovery of a reaction product with a relatively high magnetic susceptibility, according to certain embodiments.

FIG. 4 is a cross-sectional schematic illustration of a container, according to certain embodiments.

### DETAILED DESCRIPTION

Extraction of elements and/or compounds (e.g., minerals or other compounds) from iron-containing materials, such as iron-containing tailings, and related systems and products are generally described.

In accordance with certain embodiments, elements and/or compounds (e.g., minerals or other compounds) can be recovered from iron-containing (e.g., iron-rich) tailings. In some embodiments, the iron that is recovered can be suitable as a feed for a steel facility. For example, in some embodiments, the iron-containing product that is recovered contains at least 90 wt % (or at least 95 wt %, at least 98 wt %, at least 99 wt %, or more) iron (e.g., in the form of metallic iron). In some embodiments, the iron-containing product that is recovered contains less than or equal to 0.05 wt % sulfur. In some embodiments, the iron-containing product that is recovered contains less than or equal to 0.05 wt % phosphorus.

The systems and methods described herein can provide, in accordance with certain embodiments, the ability to efficiently process iron-containing (e.g., iron-rich) materials (e.g., tailings) even in the presence of aluminosilicates and/or other impurities. In addition, in accordance with some embodiments, the systems and methods described herein can provide the ability to efficiently extract different minerals and/or other compounds (e.g., metal(s), salt(s), etc.) from complex tailings structures.

Previously, other systems and methods have focused on extracting minerals from tailings, such as high purity alumina from bauxite residue. However, these processes have generally been unable to efficiently extract alumina and valorize iron, creating a process that is not economical. Other processes have tended to focus on the acquisition of one particular element, leaving the other minerals untapped. For example, scandium is a highly sought after element found in iron rich tailings. The processes used to recover scandium, though, have been very environmentally dangerous, and over 99% of the material processed remains unutilized, usually with 45 to 60 wt % of that material being iron. Certain other attempts have been made to recover iron from tailings. Most techniques involve direct reduction (at temperatures over 500° C.) using either coal, syngas, or another reducing agent with or without fluxing agents. These processes are also usually accompanied with physical separation methods like magnetic separation. However, in such systems, the aluminosilicates follow the iron through the process (and, in particular, the separation processes). Other systems have employed direct electrochemical reduction or dissolution in hydrometallurgical circuits after smelting. However, such methods do not fully account for the presence of aluminosilicates in the tailings bodies. When aluminosilicates are fired with iron rich minerals at high temperatures, complex iron minerals can form, reducing the overall yield and purity of final iron products. When these tailings are treated electrochemically or hydrometallurgically, the aluminosilicates and/or other impurities will also follow the iron into the final products. This, again, reduces the final yield and purity of the products.

Certain aspects of the present disclosure are directed to the discovery that the combination of selective leaching and magnetic separation can allow for selective extraction and recovery of high purity iron, for example, in metallic form. Certain embodiments are related to the discovery that the processes described herein can provide, in certain instances, one or more of a variety of operational advantages including, but not limited to, selective removal of impurities (e.g., aluminosilicate and/or other impurities) relative to iron-containing compounds, efficient separation of one or more impurities from each other (e.g., separation of oxide-containing impurities (e.g., alumina, silica, titanate) from impurities containing rare earth metals), recovery of selected impurities (e.g., rare earth metal impurities (e.g., rare earth metal oxides), oxide-containing impurities, actinides, etc.), lower operating temperature and/or pressure, an overall less time-consuming process, and/or reduced waste generation.

In some embodiments, a method or process for extracting iron (e.g., metallic iron) from an iron-containing material is provided. In accordance with certain embodiments, a method or process is provided by which impurities (e.g., silicates (e.g., aluminosilicates) and/or other impurities) and iron-containing material are at least partially separated to create a first stream relatively rich in silicates (e.g., aluminosilicates) and/or other impurities, and a second stream that is relatively rich in iron or an iron-containing compound. These streams can, in certain embodiments, be further processed to produce a variety of final products, as described in more detail below.

As used herein, the term “iron-containing compound” refers to a compound (i.e., a combination of two or more elements that together form a single material, such as a molecule, a salt, etc.) that contains iron. Examples of iron-containing compounds are iron oxide, iron hydroxide, and iron sulfide. The term “elemental iron” is used herein to refer to a material in which iron is present without other atoms present. Elemental iron can be in either a zero oxidation state or in ion form (e.g., dissolved Fe⁺², Fe⁺³, etc.). When iron is present in material, it is present in either compound form (in which case, it is in an iron-containing compound) or in elemental iron form. “Metallic iron” refers to a type of elemental iron in which the iron is in a zero oxidation state.

As used herein, “iron-based material” is a category that consists of iron-containing compounds and elemental iron. “Iron-containing material,” as that phrase is used herein, is used to describe materials that contain iron (e.g., in iron-containing compounds and/or in elemental iron), optionally along with one or more impurities. The term “impurities” is used herein to refer to materials other than iron-based materials (i.e., materials other than iron-containing compounds and elemental iron). For example, in a mixture of metallic iron, iron oxide, and aluminosilicates, the metallic iron and the iron oxide would be iron-based materials, and the aluminosilicate would be an impurity.

A variety of starting iron-containing materials can be used in the process. The iron-containing material can contain iron in elemental form and/or in the form of an iron-containing compound. Non-limiting examples of starting iron-containing materials include, but are not limited to, mining tailings, bauxite residues, sodalite, phyllosilicate, and/or iron slimes. In some embodiments, mining tailings can be used as a starting iron-containing material. In certain embodiments, bauxite residue (e.g., sourced from tailings ponds or residues from mining processes) can be used as a starting iron-containing material. It should be understood that the starting iron-containing is not limited to the above-referenced materials, and that any iron-containing material may be employed, as long as the iron-containing material include one or more impurities, such as those described elsewhere herein (e.g., aluminosilicate and/or other impurities).

The iron-containing material may include any of a variety of appropriate iron-containing compounds. In some embodiments, at least a portion (e.g., at least 25 wt %, at least 30 wt %, at least 40 wt %, at least 50 wt %, at least 65 wt %, at least 75 wt %, at least 90 wt %, at least 95 wt %, at least 98 wt %, at least 99 wt %, or more) of the iron in the iron-containing material is in the form of an iron-containing compound (e.g., an oxide of iron, or another compound containing iron). In some embodiments, less than or equal to 99 wt %, less than or equal to 98 wt %, less than or equal to 95 wt %, less than or equal to 90 wt %, less than or equal to 80 wt %, less than or equal to 70 wt %, less than or equal to 65 wt %, less than or equal to 50 wt %, less than or equal to 49 wt %, or less of the iron in the iron-containing material is in the form of an iron-containing compound (e.g., an oxide of iron, or another compound containing iron). Combinations of the above-referenced ranges are possible (e.g., at least 25 wt % and less than or equal to 99 wt %, or at least 40 wt % and less than or equal to 65 wt %). Other ranges are also possible.

In some embodiments, the iron-containing compound comprises one or more oxygen atoms. The iron-containing compound, according to some embodiments, may additionally include one or more non-oxygen atoms, such as hydrogen atom(s) and/or metal atom(s) that are not iron.

Non-limiting examples of iron-containing compounds include an oxide of iron, a hydroxide of iron, and/or an oxyhydroxide of iron. The iron may be present in the oxide, hydroxide, and/or oxyhydroxide in any of a variety of appropriate oxidation states, such as +3 and/or +2. In one set of embodiments, the iron-containing compounds comprise one or more oxides of iron. In one set of embodiments, the iron-containing compounds comprise one or more hydroxides of iron. In one set of embodiments, the iron-containing compounds comprise one or more oxyhydroxides of iron. In some embodiments, the iron-containing compounds comprise a mixture of oxide, hydroxide, and/or oxyhydroxide of iron. Alternatively or additionally, the iron-containing compound may be in the form of a hydrate.

Specific non-limiting examples of an oxide of iron include iron (III) oxide (e.g., hematite, maghemite, etc.), iron (II) oxide, and/or iron (II, III) oxide (e.g., magnetite). Non-limiting examples of a hydroxide of iron include iron (III) hydroxide. Non-limiting examples of an oxyhydroxide of iron include iron (III) oxyhydroxide (i.e., ferric oxyhydroxide) (e.g., akaganéite (β-FeOOH)). The iron (III) oxyhydroxide may have any of a variety of appropriate polymorphs, including, but not limited to, goethite, akageneite, lepidocrocite, and/or feroxyhyte. Non-limiting examples of a hydrate of iron may include hydrated iron (III) oxyhydroxide (e.g., limonite).

In some embodiments, the iron-containing compound includes one or more iron oxide, iron hydroxide, and/or iron oxyhydroxide containing one or more metal atom(s) that are not iron atom(s). The one or more metal atom(s) may include any of a variety of metals described elsewhere herein, e.g., transition metal(s). Non-limiting examples of these include titanium-iron oxide and/or aluminum-iron oxide.

In some embodiments, at least a portion (e.g., at least 25 wt %, at least 50 wt %, at least 75 wt %, at least 90 wt %, at least 95 wt %, at least 98 wt %, at least 99 wt %, or more) of the iron in the iron-containing material is in the form of iron oxide (e.g., hematite and/or magnetite), iron hydroxide, and/or iron oxyhydroxide. In some embodiments, less than or equal to 99 wt %, less than or equal to 98 wt %, less than or equal to 95 wt %, less than or equal to 90 wt %, less than or equal to 80 wt %, less than or equal to 70 wt %, less than or equal to 65 wt %, less than or equal to 50 wt %, less than or equal to 49 wt %, or less of the iron in the iron-containing material is in the form of an iron oxide, iron hydroxide, and/or iron oxyhydroxide. Combinations of the above-referenced ranges are possible (e.g., at least 25 wt % and less than or equal to 99 wt %, or at least 40 wt % and less than or equal to 65 wt %). Other ranges are also possible.

For example, in some embodiments, the starting iron-containing material comprises iron oxide in an amount of from 40 wt % to 65 wt %. Alternatively or additionally, in some embodiments, the starting iron-containing material comprises iron hydroxide in an amount of from 40 wt % to 65 wt %. Alternatively or additionally, in some embodiments, the starting iron-containing material comprises iron oxyhydroxide in an amount of from 40 wt % to 65 wt %.

In some embodiments, a large majority of the iron in the iron-containing material is present in a form other than elemental iron (e.g., metallic iron). In some embodiments, at least 60 wt %, at least 70 wt %, at least 80 wt %, at least 90 wt %, at least 95 wt %, at least 96 wt %, at least 98 wt %, at least 99 wt %, at least 99.5 wt %, or more, and/or up to 99.7 wt %, up to 99.9 wt %, or up to 100 wt % of the iron is present in the form of an iron-containing compound. Combinations of the above-referenced ranges are possible (e.g., at least 60 wt % and up to 100 wt %, at least 90 wt % and up to 99.9 wt %, or at least 99 wt % and up to 100 wt %). Other ranges are also possible.

In some embodiments, the starting iron-containing material may have a relatively high mass ratio of iron-containing compound relative to elemental iron (e.g., metallic iron). For example, in some embodiments, the mass ratio of iron-containing compound(s) relative to elemental iron (and, in some cases, to metallic iron) in the starting iron-containing material may be greater than or equal to 5:1, greater than or equal to 8:1, greater than or equal to 10:1, greater than or equal to 100:1, greater than or equal to 1000:1, or more, and/or up to 10⁴:1, up to 10⁵:1, up to 10⁸:1, up to 10¹⁰:1, or more. Combinations of the above-referenced ranges are possible (e.g., greater than or equal to 10:1 and up to 10¹⁰:1, or greater than or equal to 5:1 and up to 10¹⁰:1). Other ranges are also possible.

In some embodiments, a trace amount of elemental iron (e.g., metallic iron) may be present in the starting iron-containing material. For example, elemental iron may be present in the starting iron-containing material in an amount of less than or equal to 5 wt %, less than or equal to 2 wt %, less than or equal to 1 wt %, less than or equal to 0.5 wt %, less than or equal to 0.1 wt %, or less, and/or down to 0.05 wt %, down to 0.01 wt %, down to 0.005 wt %, or less. Combinations of the above-referenced ranges are possible (e.g., less than or equal to 5 wt % and down to 0.005 wt %, or less than or equal to 1 wt % and down to 0.01 wt %). Other ranges are also possible.

The iron-containing material may include any of a variety of appropriate types of impurities. In some embodiments, the impurities may be part of a gangue material present in the iron-containing material. In some embodiments, the impurities comprise a compound (e.g., a compound that is not an iron-containing compound described above) containing an oxide, a sulfide, a sulfate, an oxalate, a carbonate, a phosphate, and/or a salt). Additionally or alternatively, the impurities comprise a compound (e.g., a compound that is not an iron-containing compound described above) containing an alkali metal, an alkaline earth metal, a rare earth metal, a transition metal, a post-transition metal (e.g., aluminum and/or gallium), and/or a metalloid (e.g., silicon and/or germanium).

The term “alkali metal” is used herein to refer to the following six chemical elements of Group 1 of the periodic table: lithium (Li), sodium (Na), potassium (K), rubidium (Rb), cesium (Cs), and francium (Fr). The term “alkaline earth metal” is used herein to refer to the six chemical elements in Group 2 of the periodic table: beryllium (Be), magnesium (Mg), calcium (Ca), strontium (Sr), barium (Ba), and radium (Ra).

The “transition metal(s),” as used herein, are scandium (Sc), yttrium (Y), lanthanum (La), actinium (Ac), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), manganese (Mn), technetium (Tc), rhenium (Re), bohrium (Bh), iron (Fe), ruthenium (Ru), osmium (Os), hassium (Hs), cobalt (Co), rhodium (Rh), iridium (Ir), meitnerium (Mt), nickel (Ni), palladium (Pd), platinum (Pt), darmstadtium (Ds), copper (Cu), silver (Ag), gold (Au), roentgenium (Rg), zinc (Zn), cadmium (Cd), mercury (Hg), and copernicium (Cn).

The “post-transition metal(s),” as used herein, are aluminum (Al), gallium (Ga), indium (In), tin (Sn), thallium (Tl), lead (Pb), and bismuth (Bi).

The “metalloid(s),” as used herein, are boron (B), silicon (Si), germanium (Ge), arsenic (As), antimony (Sb), and tellurium (Te).

In one set of embodiments, the impurities may contain a small amount (e.g., a trace amount) of iron in the form of a carbonate and/or sulfide. In certain embodiments, iron in the form of a carbonate and/or sulfide (when present) may be removed from the iron-containing material via leaching (e.g., acid leaching).

In some embodiments, the impurities comprise an oxide, a hydroxide, and/or an oxyhydroxide of an alkali metal, an alkaline earth metal, a transition metal (e.g., a transition metal that is not iron), a post-transition metal, a metalloid, and/or a rare earth metal. Specific non-limiting examples of such oxides include aluminum oxide, silica, titanium oxide, sodium oxide, calcium oxide, and/or one or more rare earth metal oxides. Specific non-limiting examples of such hydroxides include aluminum hydroxide, sodium hydroxide, and/or one or more rare earth metal hydroxides. Specific non-limiting examples of such oxyhydroxides include aluminum oxyhydroxide and/or one or more rare earth metal oxyhydroxides. In some embodiments, the impurities comprise mixed oxides. For example, the impurities may comprise aluminosilicate, according to some embodiments.

In some embodiments, the impurities comprise aluminosilicate and/or one or more other impurities described elsewhere herein. Any of a variety of aluminosilicate may be present in the impurities, such as an alkali (e.g., hydrosodalite) or alkali-earth aluminosilicate (e.g., tricalcium aluminate).

In certain embodiments, it may be particularly advantageous to use the method described herein to separate impurities from one another and/or selectively recover one or more impurities described herein. For example, in one set of embodiments, the method described herein may be employed to selectively recover one or more oxide-containing impurities (e.g., aluminum oxide, silica, and/or titanium oxide) from the starting iron-containing material. Alternatively or additionally, the method described herein may be employed to selectively recover one or more rare earth metal oxides from the iron-containing material.

In some embodiments, oxide-containing impurities may be present in the starting iron-containing material in any of a variety of appropriate amounts, such as greater than or equal to 0.1 wt %, greater than or equal to 5 wt %, greater than or equal to 10 wt %, greater than or equal to 15 wt %, greater than or equal to 20 wt %, greater than or equal to 25 wt %, greater than or equal to 30 wt %, greater than or equal to 50 wt %, greater than or equal to 70 wt %, or more, and/or less than or equal to 85 wt %, less than or equal to 70 wt %, less than or equal to 50 wt %, less than or equal to 30 wt %, less than or equal to 25 wt %, less than or equal to 20 wt %, less than or equal to 15 wt %, less than or equal to 10 wt %, less than or equal to 5 wt %, or less. Combinations of the above-referenced ranges are possible (e.g., greater than or equal to 0.1 wt % and less than or equal to 85 wt %, greater than or equal to 10 wt % and less than or equal to 35 wt %, greater than or equal to 0.1 wt % and less than or equal to 10 wt %, greater than or equal to 0.1 wt % and less than or equal to 35 wt %, greater than or equal to 5 wt % and less than or equal to 25 wt %, or greater than or equal to 0.1 wt % and less than or equal to 25 wt %). Other ranges are also possible.

In some embodiments, the starting iron-containing material comprises titanium oxide. In some embodiments, the starting iron-containing material comprises titanium oxide in an amount of from 0.1 wt % to 10 wt %.

In some embodiments, the starting iron-containing material comprises aluminum oxide. In some embodiments, the starting iron-containing material comprises aluminum oxide in an amount of from 10 wt % to 35 wt %.

In some embodiments, the starting iron-containing material comprises silica (e.g., SiO₂). In some embodiments, the starting iron-containing material comprises silica (e.g., SiO₂) in an amount of from 5 wt % to 25 wt %.

In some embodiments, the starting iron-containing material comprises sodium oxide. In some embodiments, the starting iron-containing material comprises sodium oxide in an amount of from 0.1 wt % to 15 wt %.

In some embodiments, the starting iron-containing material comprises calcium oxide. In some embodiments, the starting iron-containing material comprises calcium oxide in an amount of from 0.1 wt % to 10 wt %.

In some embodiments, the impurities comprise a salt containing an alkali metal, an alkaline earth metal, a transition metal, and/or a rare earth metal. In certain embodiments, it may be particularly advantageous to use the method described herein to separate one or more salts from the other impurities and selectively recover the salts. In some embodiments, the starting iron-containing material contains salt in an amount of greater than or equal to 0.05 wt %, greater than or equal to 0.1 wt %, greater than or equal to 1 wt %, greater than or equal to 5 wt %, greater than or equal to 10 wt %, greater than or equal to 15 wt %, greater than or equal to 20 wt %, greater than or equal to 25 wt %, greater than or equal to 30 wt %, or more, and/or less than or equal to 35 wt %, less than or equal to 30 wt %, less than or equal to 25 wt %, less than or equal to 20 wt %, less than or equal to 15 wt %, less than or equal to 10 wt %, less than or equal to 5 wt %, less than or equal to 1 wt %, less than or equal to 0.1 wt %, or less. Combinations of the above-referenced ranges are possible (e.g., greater than or equal to 0.05 wt % and less than or equal to 35 wt %). Other ranges are also possible.

In some embodiments, the impurities comprise rare earth metal in the form of an oxide, a hydroxide, an oxyhydroxide, a sulfide, a sulfate, an oxalate, a carbonate, a phosphate, and/or a salt. In certain embodiments, it may be particularly advantageous to use the method described herein to selectively recover rare earth metal in one or more forms described above. In some embodiments, the starting iron-containing material comprises rare earth metal-containing impurities in an amount of greater than or equal to 0.05 wt %, greater than or equal to 0.1 wt %, greater than or equal to 1 wt %, greater than or equal to 5 wt %, greater than or equal to 10 wt %, greater than or equal to 15 wt %, greater than or equal to 20 wt %, greater than or equal to 25wt %, greater than or equal to 30 wt %, or more, and/or less than or equal to 35 wt %, less than or equal to 30 wt %, less than or equal to 25 wt %, less than or equal to 20 wt %, less than or equal to 15 wt %, less than or equal to 10 wt %, less than or equal to 5 wt %, less than or equal to 1 wt %, less than or equal to 0.1 wt %, or less. Combinations of the above-referenced ranges are possible (e.g., greater than or equal to 0.05 wt % and less than or equal to 35 wt %). Other ranges are also possible.

In some embodiments, the impurities comprise carbon. In some embodiments, the starting iron-containing material contains little or no carbon. It has been found, within the context of the present disclosure, that the presence of carbon can make recovery of iron and/or leaching of materials difficult to conduct, sometimes even resulting in the formation of organic gels. In some embodiments, the starting iron-containing material contains 0 wt % to 0.05 wt % carbon, 0 wt % to 0.15 wt % carbon, 0 wt % to 0.5 wt % carbon, 0 wt % to 1 wt % carbon, 0 wt % to 2.5 wt % carbon, 0 wt % to 10 wt % carbon, or 0 wt % to 20 wt % carbon.

In some embodiments, the impurities comprise actinides. The “actinides,” as used herein, are actinium (Ac), thorium (Th), protactinium (Pa), uranium (U), neptunium (Np), plutonium (Pu), americium (Am), curium (Cm), berkelium (Bk), californium (Cf), einsteinium (Es), fermium (Fm), mendelevium (Md), nobelium (No), and lawrencium (Lr). In certain embodiments, it may be particularly advantageous to use the method described herein to selectively recover one or more actinides (e.g., thorium and/or uranium).

In some embodiments, the impurities comprise one or more alkali metal(s), alkaline metal(s), transition metal(s) (e.g., excluding iron), rare earth metal(s), post-transition metal(s), and/or metalloid(s) in elemental form. In certain embodiments, it may be particularly advantageous to use the method described herein to selectively recover one or more metals described above in elemental form.

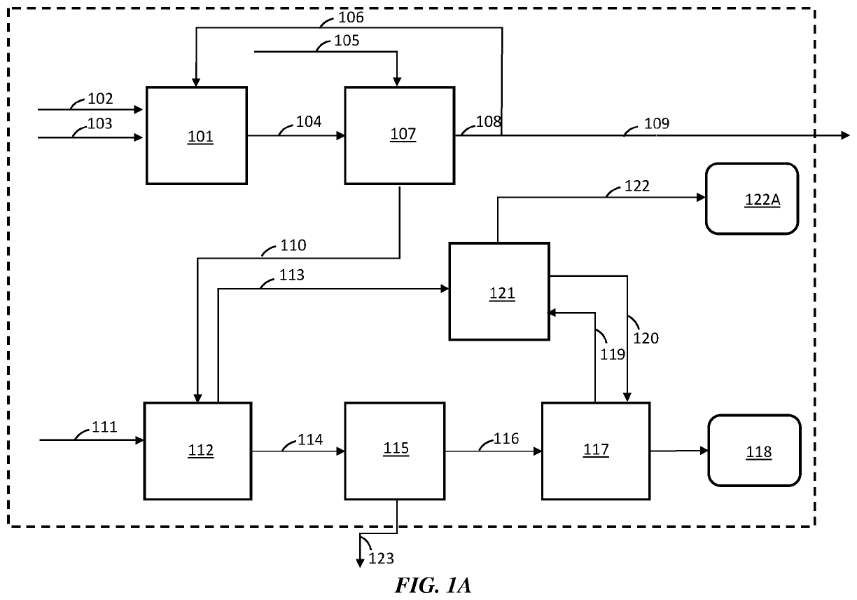

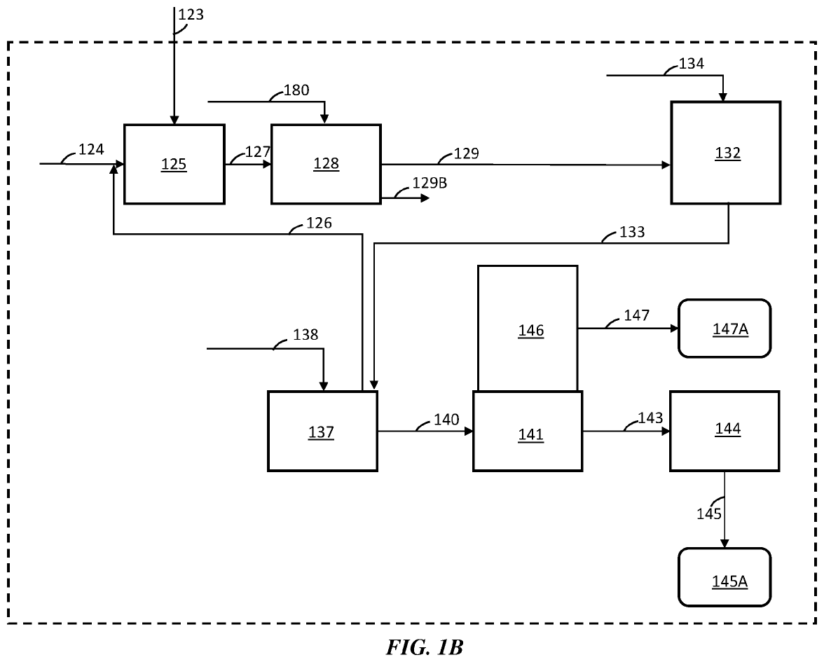

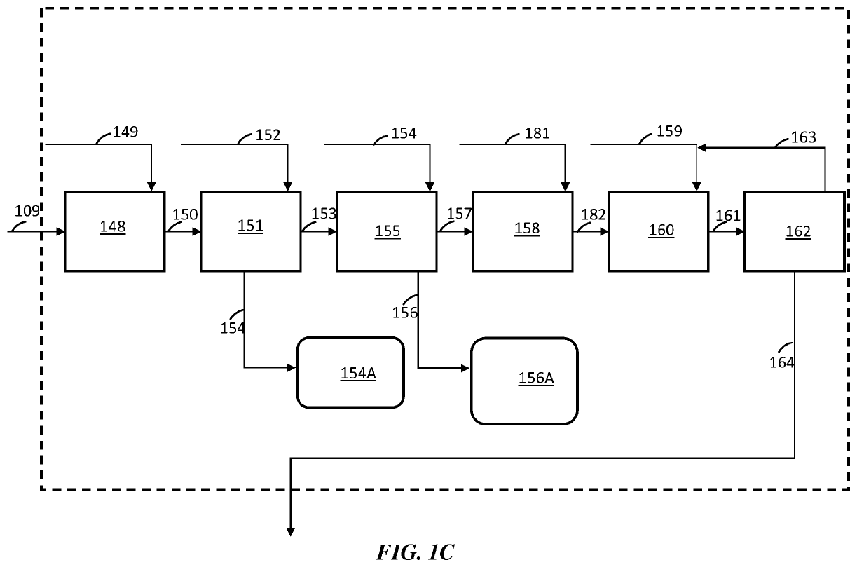

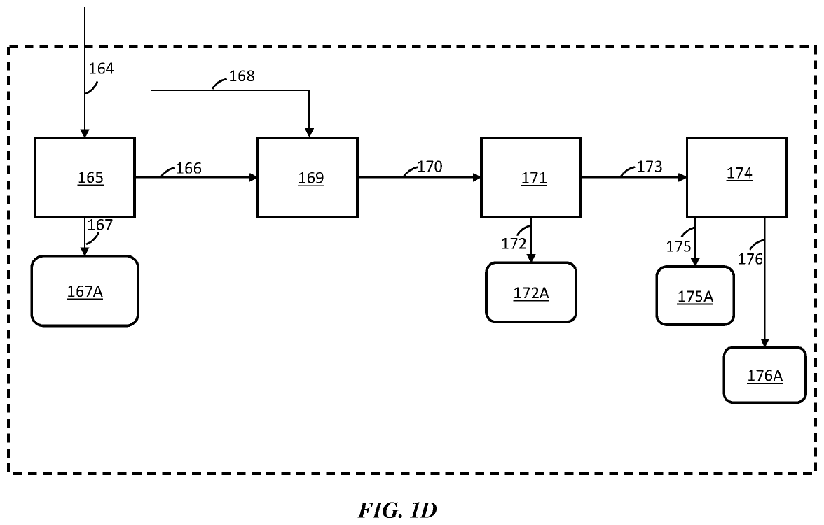

FIGS. 1A-1D are schematic illustrations showing various portions of a non-limiting system for processing iron-containing materials.

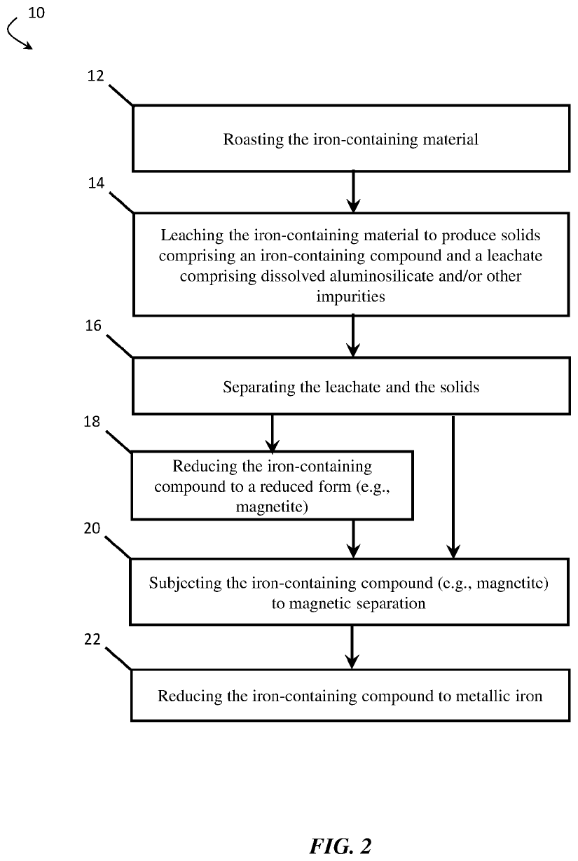

In some embodiments, the iron-containing material is roasted (not shown in FIGS. 1A-1D) before it is processed by the system. For example, as shown in FIG. 2, step 12 of method 10 comprises roasting the iron-containing material. It can be particularly advantageous to conduct roasting if the loss on ignition (LOI) of the iron-containing material is greater than 2 wt %. In some embodiments, the roasting can be conducted in an environment having a temperature of from 100° C. to 450° C. (and, in some embodiments, from 250° C. to 450° C., or from 400° C. to 450° C. In certain embodiments, the roasting can be conducted in air. In some embodiments, the roasting can be conducted for at least 30 minutes, at least 1 hour, or at least 2 hours (e.g., such as, for 2 hours). In some embodiments, the roasting can reduce the amount of carbon within the iron-containing material (e.g., by at least 50 wt %, at least 75 wt %, at least 90 wt %, at least 95 wt %, at least 99 wt %, or by 100 wt %). Experiments have shown that, if carbon removal is not properly conducted, carbonaceous material can hinder the leaching step (e.g., leading to substantial loss of yield, such as a 30% loss of yield). In some embodiments, a large portion (e.g., at least 90 wt %, at least 95 wt %, at least 98 wt %, at least 99 wt %, or 100 wt %) of the final solid product from the roasting is recovered and transported to the next step. In some embodiments, 100 wt % of the final solid product from the roasting is recovered and transported to the next step, with the remaining mass off gassed.

While FIG. 2 illustrates a set of embodiments in which the method comprises roasting the iron-containing material, it should be understood that not all embodiments described herein are so limiting, and that in certain embodiments, the iron-containing material is not roasted.

In some embodiments, after roasting (if performed), the material is subjected to hydrometallurgial processing (e.g., leaching). According to some embodiments, the method comprises leaching the iron-containing material to produce solids comprising iron-based material (e.g., iron-containing compound(s) and/or elemental iron) and a leachate comprising dissolved impurities. The impurities may include aluminosilicate and/or one or more other impurities described elsewhere herein, in some embodiments. Step 14 of FIG. 2 and FIG. 1A can be used to illustrate the leaching process, as described in more detail below.

For example, in FIG. 1A, the system includes a leaching unit 101. The leaching unit, according to some embodiments, comprises a first reactor. The first reactor comprises, according to certain embodiments, a first vessel configured such that, during operation, an iron-containing material within the first vessel is leached to produce solids comprising iron-based material (e.g., an iron-containing compound) and a leachate comprising dissolved aluminosilicate and/or other impurities. The system may further comprise a source of iron-containing material and a source of leaching agent fluidically connected to one or more inlets of the first reactor, in some embodiments. For example, as shown in FIG. 1A, the leaching unit 101 comprises a first reactor that can take in feedstock 102 (e.g., raw or roasted iron-containing material) and reagent 103 (e.g., an acid or a base) as a leaching agent within its reactor vessel. In some cases, during operation, reagent 103 and feedstock 102 may react within the vessel to produce stream 104 comprising solids (e.g., rich in iron-based material(s) (e.g., iron-containing compound(s) and/or elemental iron)) and a leachate comprising dissolved impurities (e.g., rich in aluminosilicate and/or other impurities).

In some embodiments, the iron-containing material is selectively leached to produce solids enriched in the iron-based material (e.g., an iron-containing compound) and a liquid leachate enriched in the one or more impurities. For example, in the solids, a mass fraction of the iron-based material (e.g., iron-containing compound(s)) relative to the sum of the iron-based material (e.g., the iron-containing compound(s)) and the impurities (e.g., aluminosilicate and/or other impurities) in the solids is greater than the mass fraction of the iron-based material (e.g., the iron-containing compound(s)) relative to the sum of the iron-based material (e.g., the iron-containing compound(s)) and the impurities (e.g., aluminosilicate and/or other impurities) in the iron-containing material. Conversely, in the leachate, a mass fraction of the impurities (e.g., aluminosilicate and/or other impurities) relative to the sum of the iron-based material (e.g., the iron-containing compound(s)) and the impurities (e.g., aluminosilicate and/or other impurities) in the leachate is greater than the mass fraction of the aluminosilicate and/or other impurities relative to the sum of the iron-based material (e.g., the iron-containing compound(s)) and the impurities (e.g., aluminosilicate and/or other impurities) in the iron-containing material.

For example, in the resulting solids, the mass fraction of the iron-based material (e.g., the iron-containing compound(s)) relative to the sum of the iron-based material (e.g., the iron-containing compound(s)) and the impurities (e.g., aluminosilicate and/or other impurities) in the solids is at least 1.1 times (e.g., at least 1.2 times, at least 1.5 times, at least 2 times, at least 2.5 times, or more, and/or up to 5 times, or more) the mass fraction of the iron-based material (e.g., the iron-containing compound(s)) relative to the sum of the iron-based material (e.g., the iron-containing compound(s)) and the impurities (e.g., aluminosilicate and/or other impurities) in the iron-containing material. Conversely, in the resulting leachate, a mass fraction of the impurities (e.g., aluminosilicate and/or other impurities) relative to the sum of the iron-based material (e.g., the iron-containing compound(s)) and the impurities (e.g., aluminosilicate and/or other impurities) in the leachate is at least 1.1 times (e.g., at least 1.2 times, at least 1.5 times, at least 2 times, at least 2.5 times, or more, and/or up to 5 times, or more) the mass fraction of the impurities (e.g., aluminosilicate and/or other impurities) relative to the sum of the iron-based material (e.g., the iron-containing compound(s)) and the impurities (e.g., aluminosilicate and/or other impurities) in the iron-containing material. In one set of embodiments, the leaching comprises leaching the iron-containing material to produce solids comprising (and enriched in) iron oxide, hydroxide, and/or oxyhydroxide, and a leachate comprising (and enriched in) dissolved aluminosilicate and/or other impurities. In some cases, the solids produced comprise an iron (III) oxide, hydroxide, and/or oxyhydroxide (e.g., hematite and/or goethite). Alternatively or additionally, the solids produced comprise magnetite.

In some embodiments, the leaching comprises exposing the iron-containing material to a leaching agent. The leaching agent, according to some embodiments, may selectively leach (e.g., dissolve) one or more impurities from the iron-containing material, thereby leaving the solids comprising the iron-based material (e.g., the iron-containing compound(s)).

According to some embodiments, the leaching comprises either acid leaching or caustic leaching, depending on the composition of the iron-containing material. For example, in one set of embodiments, when a mass ratio of the total amount of alkali metal and/or alkaline earth metal relative to the total amount of metals that are not alkali or alkaline earth metal is greater than or equal to 1:6 (e.g., greater than or equal to 1:5, greater than or equal to 1:3, greater than or equal to 1:2, greater than or equal to 1:1, or more, and/or up to 2:1, up to 3:1, up to 5:1, up to 10:1, or more) in the iron-containing material, acid leaching may be employed. Combinations of the above-referenced ranges are possible (e.g., greater than or equal to 1:6 and up to 5:1). Other ranges are also possible.

In some embodiments in which acid leaching is employed, one or more impurities containing an alkali metal, an alkaline earth metal, and/or a rare earth metal may be selectively leached from the iron-containing material and dissolved into the leachate. In some such embodiments, in the resulting leachate, a mass fraction of the impurities (e.g., impurities containing an alkali metal, an alkaline earth metal, and/or a rare earth metal) relative to the sum of the iron-based material (e.g., the iron-containing compound(s)) and the impurities in the leachate is greater than the mass fraction of the impurities (e.g., impurities containing an alkali metal, an alkaline earth metal, and/or a rare earth metal) relative to the sum of the iron-based material (e.g., the iron-containing compound(s)) and the impurities in the iron-containing material.

In certain embodiments in which acid leaching is performed, at least 25 wt %, at least 50 wt %, at least 60 wt %, at least 75 wt %, or at least 95 wt % (and/or up to 100 wt %) of impurities containing an alkali metal, an alkaline earth metal, and/or a rare earth metal are recovered in the leachate. For example, in certain embodiments in which acid leaching is performed, at least 25 wt %, at least 50 wt %, at least 60 wt %, at least 75 wt %, or at least 95 wt % (and/or up to 100 wt %) of impurities containing an alkali metal and/or an alkaline earth metal is recovered in the leachate. Alternatively or additionally, at least 25 wt %, at least 50 wt %, at least 60 wt % (and/or up to 90 wt %) of impurities containing rare earth metal(s) is recovered in the leachate.

In some embodiments, if the iron-containing material has a mineralogical composition comprising impurities containing alkali or alkaline earth metal or some mixture of the two that have a ratio greater than 1:1 (e.g., greater than or equal to 2:1, greater than or equal to 3:1, greater than or equal to 4:1, or more, and/or up to 6:1, up to 8:1, up to 10:1, or more) (by mass) compared to impurities containing non-alkali or non-alkali-earth metal(s), then acid leaching is performed. For example, in certain embodiments, if the iron-containing material has a mineralogical composition of alkali (e.g., hydrosodalite) or alkaline earth aluminosilicates (e.g., tricalcium aluminate) or some mixture of the two that has a ratio greater than 1:1 (e.g., greater than or equal to 2:1, greater than or equal to 3:1, greater than or equal to 4:1, or more, and/or up to 6:1, up to 8:1, up to 10:1, or more) (by mass) compared to non-alkali or non-alkaline earth aluminosilicates, then acid leaching is performed. In some such embodiments, alkali, alkaline earth, and rare earth metal species are dissolved into solution. In certain embodiments in which acid leaching is performed, at least 25 wt %, at least 50 wt %, or at least 95 wt % (and/or up to 100 wt %) of sodium and calcium are recovered in the leachate. In certain embodiments in which acid leaching is performed, at least 5 wt %, at least 25 wt %, or at least 60 wt % (and/or up to 90 wt %) of rare earth metals are recovered in the leachate. In some such embodiments, the remainder of the sodium, calcium, and rare earth metals remain in the solids.

Any of a variety of appropriate types of acid may be employed for the acid leaching. Non-limiting examples of acids include sulfuric acid, hydrochloric acid, and/or nitric acid. The acid may be present in any of a variety of concentrations, such as 0.1 to 12 M, from 0.25 to 6 M, or from 0.5 to 4 M.

In some embodiments, the acid leaching is carried out at a relatively low pH, such as less than or equal to 1, less than or equal to 0.8, less than or equal to 0.6, less than or equal to 0.4, or less, and/or down to 0.3, down to 0.2, down to 0.1, down to 0, down to −1.08, down to −1.1, or less. Combinations of the above-referenced ranges are possible (e.g., less than or equal to 1 and down to 0.1, less than or equal to 1 and down to −1.08, or less than or equal to 1 and down to −1.1). Other ranges are also possible.

In some embodiments, the acid leaching is carried out at a relatively moderate temperature. In some embodiments, the acid leaching is carried out at a temperature of greater than or equal to 50° C., greater than or equal to 60° C., greater than or equal to 70° C., greater than or equal to 80° C., greater than or equal to 90° C., or more, and/or less than or equal to 100° C., less than or equal to 90° C. less than or equal to 80° C., less than or equal to 70° C., or less than or equal to 60° C. Combinations of the above-referenced ranges are possible (e.g. greater than or equal to 50° C. and less than or equal to 100° C.). Other ranges are also possible.

In some embodiments, when a mass ratio of the total amount of alkali metal and/or alkaline earth metal relative to the total amount of metals that are not alkali or alkaline earth metal is less than or equal to 1:10 (e.g., less than or equal to 1:12, less than or equal to 1:15, less than or equal to 1:20, less than or equal to 1:50, or less, and/or down to 1:100, down to 1:200, down to 1:1000, or less) in the iron-containing material, caustic leaching may be employed. Combinations of the above-referenced ranges are possible (e.g., less than or equal to 1:10 and down to 1:1000). Other ranges are also possible.

In some embodiments, when a mass ratio of the total amount of alkali metal and/or alkaline earth metal relative to the total amount of metals that are not alkali or alkaline earth metal is less than or equal to 1:6 (e.g., less than or equal to 1:7, less than or equal to 1:8, less than or equal to 1:9, or less, and/or greater than or equal to 1:10, greater than or equal to 1:9, greater than or equal to 1:8, greater than or equal to 1:7, or more) in the iron-containing material, either caustic leaching or acid leaching may be employed, depending on the dominant mineral species within the iron-containing material, Combinations of the above-referenced ranges are possible (e.g., between 1:10 and 1:6). Other ranges are also possible. For example, in embodiments in which the dominant mineral species within the iron-containing material comprises a neutral mineral structure (e.g., kaolin or phyllosilicates), base leaching may be carried out. Alternatively, acid leaching may be carried out.

In some embodiments, a combination of acid leaching and caustic leaching may be performed. For example, a round of acid leaching may be performed (e.g., if the elemental compositions are such that acid leaching is initially preferred) followed by a round of caustic leaching (e.g., due to the elemental composition becoming more favorable for caustic leaching due to the performance of the acid leaching). In some embodiments, a round of caustic leaching may be performed (e.g., if the elemental compositions are such that caustic leaching is initially preferred) followed by a round of acid leaching (e.g., due to the elemental composition becoming more favorable for acid leaching due to the performance of the caustic leaching). In some embodiments, a first round of leaching (e.g., acid leaching) may be carried out to remove one or more impurities from the iron-containing material, followed by a second round of leaching (e.g., caustic leaching) to remove one or more impurities from the already-leached iron-containing material. Alternatively, the first round of leaching may be caustic leaching, while the second round of leaching may be acid leaching, according to some embodiments. The second round of leaching may be employed to remove target impurities that are the same or different from the impurities removed by the first round of leaching, in certain embodiments. In some cases, the second round of leaching may be advantageously employed to remove different target impurities from the first round of leaching.

In embodiments in which caustic leaching is employed, one or more impurities containing an alkali metal, a post-transition metal (e.g., aluminum), a metalloid (e.g., silicon), and/or a rare earth metal may be selectively leached from the iron-containing material and dissolved into the leachate. In some such embodiments, in the resulting leachate, a mass fraction of the impurities (e.g., impurities containing an alkali metal, a post-transition metal (e.g., aluminum), a metalloid (e.g., silicon), and/or a rare earth metal) relative to the sum of the iron-based material (e.g., iron-containing compound(s)) and the impurities in the leachate is greater than the mass fraction of the impurities (e.g., impurities containing an alkali metal, a post-transition metal (e.g., aluminum), a metalloid (e.g., silicon), and/or a rare earth metal) relative to the sum of the iron-based material (e.g., iron-containing compound(s)) and the impurities in the iron-containing material.

In certain embodiments in which caustic leaching is performed, at least 25 wt %, at least 50 wt %, at least 75 wt %, or at least 95 wt % (and/or up to 100 wt %) of impurities containing an alkali metal, a post-transition metal (e.g., aluminum), a metalloid (e.g., silicon), and/or a rare earth metal is recovered in the leachate. For example, in certain embodiments, at least 15 wt %, at least 30 wt %, or at least 60 wt % (and/or up to 95 wt %) of impurities containing a post-transition metal and/or metalloid are recovered in the leachate. Alternatively or additionally, at least 5 wt %, at least 15 wt %, or at least 25 wt % (and/or up to 90 wt %) of rare earth metals are recovered in the leachate.

In some embodiments, if the iron-containing material has a mineralogical composition comprising impurities containing non-alkali or non-alkaline earth metal some mixture of the two that have a ratio greater than 1:1 (e.g., greater than or equal to 2:1, greater than or equal to 3:1, greater than or equal to 4:1, or more, and/or up to 6:1, up to 8:1, up to 10:1, or more) (by mass) compared to impurities containing alkali and/or non-alkaline earth metal, then caustic leaching is performed. For example, in certain embodiments, if the iron-containing material has non-alkali or non-alkaline earth aluminosilicates with a ratio greater than 1:1 (e.g., greater than or equal to 2:1, greater than or equal to 3:1, greater than or equal to 4:1, or more, and/or up to 6:1, up to 8:1, up to 10:1, or more) (by mass) compared to alkali or alkaline earth aluminosilicates, then caustic leaching is performed. In some such embodiments, alkali, aluminum, silicon, and rare earth species are dissolved into solution. In certain embodiments in which caustic leaching is performed, at least 15 wt %, at least 30 wt %, or at least 60 wt % (and/or up to 95 wt %) of aluminum and silicon are recovered in the leachate. In certain embodiments in which caustic leaching is performed, at least 5 wt %, at least 15 wt %, or at least 25 wt % (and/or up to 90 wt %) of rare earth metals are recovered in the leachate. In some such embodiments, the remainder of the aluminum, silicon, and rare earth metals remain in the solids.

Any of a variety of appropriate types of caustic may be employed for the caustic leaching. Non-limiting examples of caustic include sodium hydroxide, ammonia, and/or potassium hydroxide. The caustic may be present in any of a variety of concentrations, such as 0.1 to 12 M, from 0.25 to 6 M, or from 0.5 to 4 M.

In some embodiments, the caustic leaching is carried out at a relatively high pH, such as greater than or equal to 12, greater than or equal to 12.5, greater than or equal to 13, greater than or equal to 13.5, or greater, and/or up to 13.7, up to 13.9, up to 14, up to 15, up to 15.12, up to 15.5, or more. Combinations of the above-referenced ranges are possible (e.g., greater than or equal to 12 and up to 14, greater than or equal to 12 and up to 15.12, or greater than or equal to 12 and up to 15.5). Other ranges are also possible.

In some embodiments, the caustic leaching is carried out at a relatively moderate temperature. For example, in some embodiments, the caustic leaching is carried out at a temperature of greater than or equal to 50° C., greater than or equal to 80° C., greater than or equal to 100° C., greater than or equal to 150° C., greater than or equal to 200° C., greater than or equal to 250° C., or more, and/or less than or equal to 300° C., less than or equal 250° C., less than or equal 200° C., less than or equal 150° C., or less than or equal 100° C. Combinations of the above-referenced ranges are possible (e.g. greater than 50° C. less than or equal to 300° C.). Other ranges are also possible.

The leaching may be performed for any of a variety of appropriate durations, such as for at least 0.5 hours, at least 1 hour, at least 1.5 hours, at least 4 hours, at least 8 hours, at least 10 hours, or more, and/or less than or equal to 12 hours, less than or equal to 10 hours, less than or equal to 8 hours, less than or equal to 4 hours, less than or equal to 1.5 hours, less than or equal to 1 hour, or less. Combinations of the above-referenced ranges are possible (e.g., for 0.5 hours to 12 hours, for 1 hour to 8 hours, or for 1.5 hours to 4 hours). Other ranges are also possible.

In some embodiments, after hydrometallurgical processing (e.g., leaching) is performed, a solid-liquid separation is run to separate the two streams (e.g., solids and leachate) from each other, as illustrated by step 16 of FIG. 2 and FIG. 1A. For example, in FIG. 1A, leaching product stream 104 is transported to solid-liquid separator 107, which is used to produce stream 108 (e.g., leachate comprising one or more impurities described elsewhere herein such as silicate, aluminate, rare earth metal hydroxide (e.g., REOH), etc.) and stream 110 (e.g., a residue stream of solids that is rich in one or more iron-based material (e.g., iron-containing compounds described elsewhere herein (e.g., hematite))). As shown, the solid-liquid separator may be fluidically connected to an outlet of the first reactor in the leaching unit (e.g., unit 101).

In some embodiments, solid-liquid separator 107 comprises a filter. Separation can be achieved, in some embodiments, using a thickener. The liquid separated here can then be reused, in some embodiments, in the leaching system. In some embodiments, stream 105 contains a flocculant which can be used, for example, to crash out iron rich components in the thickener. In some embodiments, stream 106 receives the excess overflow from unit 107 and recycles it back into unit 101 for additional leaching to take place.

In some embodiments, the method comprises reducing the iron-containing compound in the separated solids to metallic iron, e.g., as shown in step 22 of FIG. 2. Depending on the type of iron-containing compound, the reducing step may be carried out via a single step or a multi-step process, according to some embodiments. For example, in embodiments in which the iron-containing compound comprises predominantly magnetite, a single reducing step may be carried out to reduce the magnetite to metallic iron, e.g., as shown in step 22. In some such embodiments, prior to the reducing, the method comprises subjecting the iron-containing compound to magnetic separation such that a magnetite-rich stream is produced, e.g., as shown in step 20 of FIG. 2.

For another example, in embodiments in which the iron-containing compound comprises predominantly iron (III) oxide, hydroxide, and/or oxyhydroxide (e.g., hematite and/or goethite), the reducing may occur via a multi-step process, e.g., such as comprising a first step (e.g., as shown by step 18 of FIG. 2) of reducing the iron-containing compound in the solids to magnetite prior to a second step (e.g., as shown by step 22 of FIG. 2) of reducing the magnetite to metallic iron, according to some embodiments. In some cases, it may be particularly advantageous to reduce the iron-containing compound(s) (e.g., iron (III) oxide, hydroxide, and/or oxyhydroxide) to magnetite, which is a magnetically susceptible iron-containing compound, prior to further reduction to metallic iron. As a magnetically susceptible iron-containing compound, magnetite can be efficiently magnetically separated from other iron-containing residue materials and/or impurities within the solids. For example, in some such embodiments, prior to the second step of reducing (e.g., step 22), the method comprises subjecting the iron-containing compound to magnetic separation such that a magnetite-rich stream is produced, as shown in step 20 of FIG. 2.

In some embodiments, the first reducing step is performed to convert a less or non-magnetically susceptible iron-containing compound to a more magnetically susceptible iron-containing compound, such that the converted iron-containing compound may be efficiently extracted via magnetic means. For example, in certain embodiments, the first reducing step is performed to convert a less or non-ferromagnetic form of iron-containing compound to a more ferromagnetic form of iron-containing compound.

In some embodiments, the reduction of the iron-containing compound is carried via a solid-state reaction (e.g., in the absence of (or presence of a negligible amount) of liquid medium). The one or more reducing steps described herein comprise exposing the solids comprising the iron-containing compound to one or more reducing gases, according to some embodiments. Non-limiting examples of reducing gases include hydrogen, syngas, and/or methane.

The one or more reducing steps described herein may be carried out at any of a variety of appropriate temperatures, such as a temperature of greater than or equal to 300° C., greater than or equal to 400° C., greater than or equal to 500° C., greater than or equal to 600° C., or more, and/or less than or equal to 650° C., less than or equal 600° C. less than or equal 500° C., less than or equal 400° C., or less. Combinations of the above-referenced ranges are possible (e.g. greater than or equal to 300° C. and less than or equal to 650° C.). Other ranges are also possible.

FIG. 1A can be used to illustrate a set of embodiments in which the method comprises a multi-step reducing process. In certain embodiments, a first step of reducing is performed on the solids exiting the solid-liquid separator. As shown in FIG. 1A, iron reduction processing is performed on the solid materials from stream 110 from the solid-liquid separator 107. In some embodiments, the solid materials are pre-heated, and a reducing gas (e.g., hydrogen, syngas, and/or methane) is used to convert the iron-containing compound (e.g., ferric oxide rich material (e.g., hematite)) in the solid material into magnetite rich material. For example, as shown in FIG. 1A, stream 110 and reducing gas (e.g., via stream 111) can be fed to iron reduction unit 112. The system may further comprise a gaseous source (not shown) comprising one or more reducing gases and fluidically connected to an inlet of the second reactor within iron reduction unit 112, in some embodiments.

In some embodiments, the iron reduction unit described above (e.g., unit 112) comprises a second reactor, where the second reactor is fluidically connected to an outlet of the solid-liquid separator (e.g., unit 107), as shown in FIG. 1A. The iron reduction unit (e.g., unit 112) comprises a second vessel configured to reduce the iron-containing compound in the solids to a magnetically susceptible iron-containing material (e.g., magnetite), in some embodiments.

In some embodiments, the reducing gas and the iron-containing compound in the reducing unit react to produce a magnetite-rich stream and a gas effluent stream. For example, as shown in FIG. 1A, operation of iron reduction unit 112 can produce magnetite rich stream 114 and gas effluent stream 113. The use of reducing gas in the iron reduction unit is not required, and other possible methods involve using hydrazine or starch in aqueous solutions. In some embodiments, at least 25 wt %, at least 30 wt %, at least 40 wt %, at least 50 wt %, at least 60 wt %, at least 70 wt %, or at least 85 wt % (and/or up to 90 wt %, up to 95 wt %, or up to 98 wt %, or more) of the iron-containing compound from stream 110 is converted to magnetite.

In some embodiments, the magnetite-rich material (e.g., in stream 114) is subjected to magnetic separation to produce a first stream that is further enriched in magnetite compared to the magnetite-rich stream and a second stream that is lean in magnetite (e.g., contains little to no magnetite). The second stream may contain predominantly other iron-containing compounds, e.g., those that are less or not susceptible to magnetic separation compared to magnetite (such as one or more of iron (III) oxide, hydroxide, and/or oxyhydroxide (e.g., hematite or goethite)), according to some embodiments. This step can be used, for example, to increase the overall purity of the product. Referring to FIG. 1A, for example, stream 114 containing magnetite-rich material is transported to magnetic separator 115, which produces first stream 116 that is even more rich in magnetite than stream 114 and second stream 123 that is lean in magnetite (e.g., a stream comprising iron-containing compounds such as hematite rich residue). In some embodiments, the magnetic separator (e.g., unit 115) is fluidically connected to an outlet of the second reactor within the iron reduction unit (e.g., unit 112). The magnetic separator is configured to magnetically separate magnetically susceptible iron-containing material (e.g., magnetite) from the solids, according to some embodiments.

In some embodiments, the stream (e.g., stream 116 as shown in FIG. 1A) that is further enriched in magnetite may comprise magnetite in an amount that is at least 1.1 times (e.g., at least 1.2 times, at least 1.5 times, at least 2 times, at least 5 times, or more, and/or up to 10 times), by mass, the amount of magnetite in the stream comprising magnetite-rich material (e.g., stream 114 as shown in FIG. 1A).

In certain embodiments, the further-enriched magnetite rich stream is subjected to another reduction process (e.g., a second reducing step). The further reduction process can be used to convert the further-enriched magnetite rich stream to iron powder (e.g., comprising metallic iron). The iron powder can be, in accordance with certain embodiments, contained in inert gas. Any of a variety of appropriate reducing gasses and/or agents may be employed, as described above.

The second reducing step may be carried out in an additional iron reduction unit (e.g., unit 117 as shown in FIG. 1A), according to some embodiments. As shown in FIG. 1A, additional iron reduction unit 117 comprises a third reactor fluidically connected to an outlet of the magnetic separator 115, according to some embodiments. Additional iron reduction unit 117 may comprise a third vessel configured such that, during operation, the magnetically susceptible iron-containing material (e.g., magnetite) is reduced to metallic iron. The system may further comprise a gaseous source (not shown) comprising one or more reducing gases and fluidically connected to an inlet of the third reactor within additional iron reduction unit 117, in some embodiments.

For example, referring to FIG. 1A, in some embodiments, stream 116 is transported to iron reduction unit 117 (e.g., along with a reducing stream that may include any of the reducing agents mentioned above or elsewhere herein), which is used to produce iron powder 118 and reducing agent effluent stream 118. In some embodiments, the second iron reduction unit can convert at least 10 wt %, at least 20 wt %, at least 30 wt %, at least 40 wt %, at least 50 wt %, at least 65 wt %, at least 80 wt %, or at least 95 wt % (and/or up to 98 wt %) of the magnetite in stream 116 to iron powder.

In some embodiments, the one or more gas effluent streams described above can be transported to a unit comprising a heat exchanger and/or a gas scrubber, which can be used to produce cleaned gas effluent. For example, as shown in FIG. 1A, heat exchanger and/or a gas scrubber unit 121 may be fluidically connected to an outlet of the second reactor and/or the third reactor within the within various iron reduction units (e.g., unit 112 and/or 117). In some embodiments, gas effluent streams 113 and/or 119 can be transported to a heat exchanger and gas scrubber unit 121, which can be used to produce cleaned gas effluent 122. Cleaned gas effluent can be stored in unit 122A for future use.

The resulting iron powder may comprise metallic iron at a relatively high purity level. For example, the metallic iron may be present in the iron powder in an amount of least 90 wt %, at least 95 wt %, at least 96 wt %, at least 98 wt %, at least 99 wt %, or more, and/or up to 99.5 wt %, up to 99.9 wt %, or up to 100 wt %.

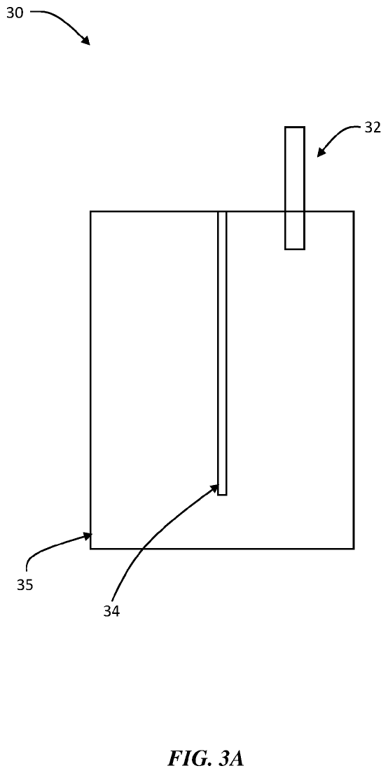

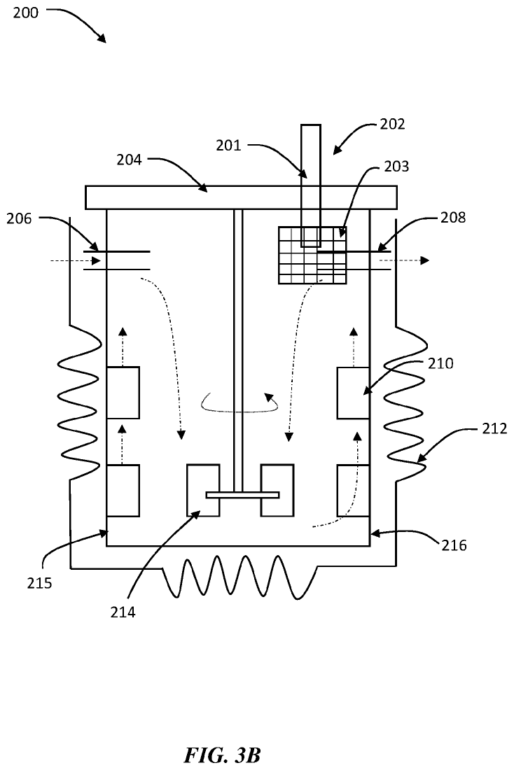

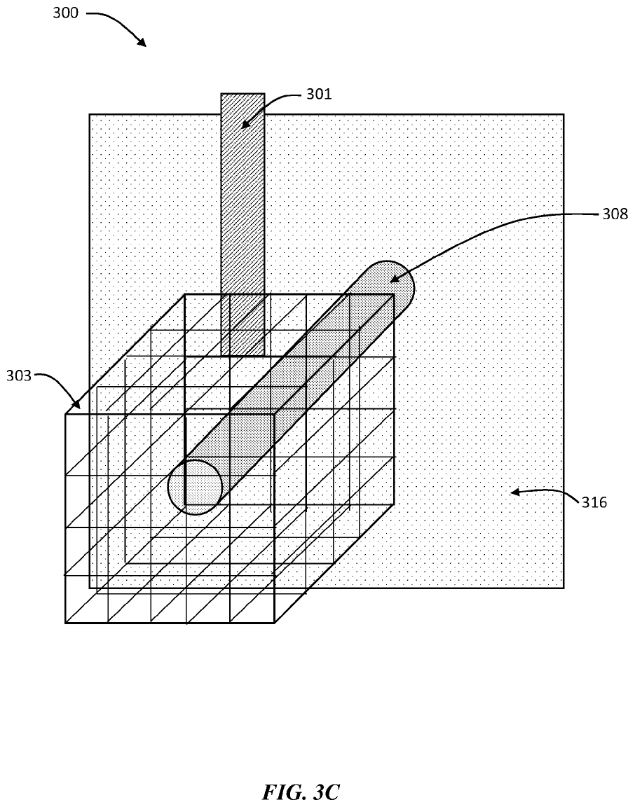

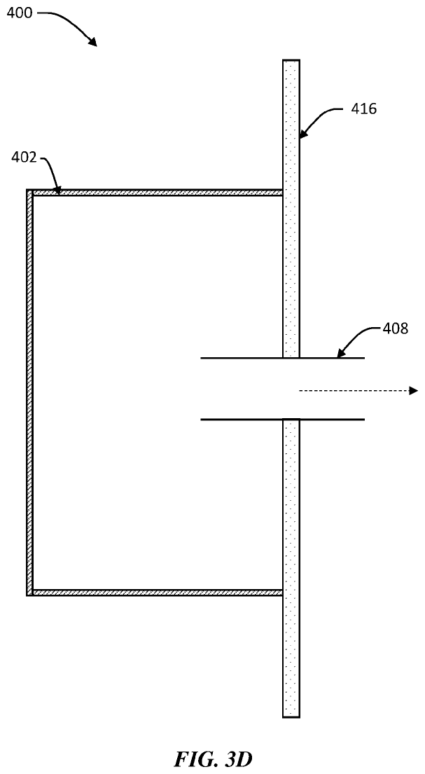

While FIG. 1A illustrates a set of embodiments in which the method comprises a multi-step reducing process, it should be understood that not all embodiments described herein are not so limiting, and in other embodiments, a single step reducing process may be carried out to reduce the iron-containing compound. For example, as shown in FIG. 1A, in embodiments in which the solids in stream 110 comprise predominantly magnetite as opposed to other iron-containing compounds (e.g., iron (III) oxide, hydroxide, and/or oxyhydroxide such as hematite or goethite), a single step of reducing may be carried out. For example, the solids in stream 110 may be fed directly to magnetic separator 115 for magnetic separation to produce first stream 116 that is further enriched in magnetite compared to magnetite-rich stream 114 and second stream 123 that is lean in magnetite (e.g., contain little to no magnetite). The further enriched stream 116 may be subjected to a single step of reduction in iron reduction unit 117 to produce iron powder comprising metallic iron. As described in more detail below, the single step reducing process may be carried using a single reactor configured to carry out both the magnetic separation and the reduction, as shown in FIGS. 3A-3D.

In some embodiments, the method further comprises producing iron oxide pigments from residual iron-containing material produced by the magnetic separation. For example, as noted above, the magnetic separator may be configured to output a second stream (e.g., stream 123 as shown in FIG. 1A) comprising solids that contain predominantly other iron-containing compounds (e.g., compounds that are not magnetite), according to some embodiments. For example, in one set of embodiments, second stream 123 may be a stream comprising solids that are rich in iron (III) oxide, hydroxide, and/or oxyhydroxide (e.g., hematite and/or goethite). In some cases, the solids may contain a trace amount of impurities described elsewhere herein.

In some embodiments, residual iron-containing material produced by the magnetic separation may be further processed to produce iron-rich pigments. For example, FIG. 1B is a schematic illustration of a system for producing iron oxide based pigments from residual iron-containing materials produced from the process illustrated in FIG. 1A. In certain embodiments, iron-containing compounds (e.g., hematite rich material) that does not get picked up by the magnetic separation process (e.g., within stream 123) is leached with acid (e.g., within stream 124) to dissolve all components except silica (when present). For example, in FIG. 1B, stream 123 can be transported to leaching unit 125, which can be used to produce stream 127 containing solid silica and dissolved materials as a leachate. In some embodiments, at least 25 wt %, at least 30 wt %, at least 40 wt %, at least 50 wt %, at least 60 wt %, at least 75 wt %, or at least 90 wt % (and/or up to 95 wt %) of solids that are not silica are dissolved in the leaching agent.

In some embodiments, the acid concentration that is used can be at least 1 M, at least 2 M, at least 4 M, at least 6 M, at least 8 M, or more, and/or no more than 12 M, no more than 8M, no more than 6 M, no more than 4 M, no more than 2 M, or less. Combinations of the above-referenced ranges are possible (e.g., 1 M to 12 M, 2 M to 8M, or 4 M to 6 M).

The temperature at which this step is performed can be from at least 25° C., at least 40° C., at least 55° C., or more, and/or up to 80° C., at least 85° C., at least 90° C., or more. Combinations of the above-referenced ranges are possible (e.g., 25° C. to 90° C., 40° C. to 85° C., or 55° C. to 80° C.).

The step can be performed for any of a variety of appropriate durations, such as at least 0.25 hours, at least 0.5 hours, at least 0.75 hours, or more, and/or up to 2 hours, up to 2.5 hours, up to 4 hours, or more. Combinations of the above-referenced ranges are possible (e.g., 0.25 to 4 hours, 0.5 to 2.5 hours, or 0.75 to 2 hours). These processes may be performed, in certain embodiments, in a stirred tank. In some embodiments, stream 124 contains a strong, inorganic acid, non-limiting examples of which include sulfuric acid, nitric acid, hydrochloric acid, or mixtures thereof.

In some embodiments, the acidic leachate and the solids within stream 127 are separated from each other using a solid-liquid separator. For example, referring to FIG. 1B, acidic leachate and solids within stream 127 are transported to solid-liquid separation unit 128. In some embodiments, unit 128 comprises a filter. Separation can be achieved, in some embodiments, using a thickener. The liquid separated in this step can then be reused in the leaching system. In some embodiments, stream 129B is produced by unit 128. Stream 129B can contain, for example, solid silica, which can be separated from stream 129. In some embodiments, stream 180 contains a flocculant which can be used, for example, to crash out silica rich components in the thickener. In some embodiments, stream 129 is an iron rich solution which may optionally include one or more impurities such as aluminum, titanium, and/or silicon compounds (e.g., in trace amounts).

The acidic leachate (e.g., within stream 129) can then undergo, in some embodiments, selective precipitation and/or neutralization (e.g., using caustic such as sodium hydroxide or ammonia) to remove iron from the leachate. For example, in FIG. 1B, nucleation site formation and/or precipitation can occur in unit 132. Unit 132 can also be used to perform neutralization. In some embodiments, at least 50 wt %, at least 60 wt %, at least 75 wt %, at least 80 wt %, or at least 85 wt % (and/or up to 90 wt %, up to 99 wt %, or up to 100 wt %) of dissolved iron within the acidic leachate is precipitated. In some embodiments, stream 134 comprises caustic (e.g., sodium hydroxide/ammonia) that can be used to selectively crash out the iron from the acidic leaching within stream 129, typically as an oxide. In some embodiments, the iron oxide can be in the form of hematite, magnetite, and/or goethite, generally depending on the pH and salinity levels of incoming material.

In certain embodiments, the precipitated iron and the leachate (e.g., within stream 133) are separated from each other using a solid liquid separation process. For example, in FIG. 1B, the precipitated iron and the leachate are fed into solid-liquid separator 137, which is used to produce streams 140 and 126. Stream 133 can contain solidified iron product, and may also contain any remaining oxide-containing impurities (e.g., alumina and titania) in solution. In some embodiments, stream 133 contains little or no silica.

In some embodiments, stream 126 is recycled back to unit 125. Stream 126 can contain, for example, an acidic mixture, for example containing dissolved impurities (e.g., aluminum, titanium, and (trace) silicon compounds). In some embodiments, unit 137 comprises a filter. Separation can be achieved, in some embodiments, using a thickener. In some embodiments, stream 138 comprises a flocculant that selectively crashes out iron rich compounds.

Unit 137 can also produce stream 140, which can comprise a wet powder (which may contain one or more iron-rich pigments). Stream 140 can be transported to unit 141. Unit 141 can be, for example, a grinder, which can be used to perform wet grinding. After separation of stream 140 in unit 137, the stream can be passed through a classification cyclone. After this process, the light material can proceed to a filter press in preparation to be dried, and the heavy material can be circulated to a vertical grinding mill, utilizing wet media grinding.

In some embodiments, stream 143 will contain at least 30 wt % solids (and/or as much as 50 wt %, or as much as 60 wt % solids), for example, of iron rich pigment material (e.g., iron-oxide based pigments). Stream 143 can be transported to drying unit 144. In some embodiments, the dryer is operated at a temperature of 25° C. to 300° C., 60° C. to 250° C., or 70° C. to 200° C. The drying can be performed for 0.125 to 4 hours, from 0.25 to 2.5 hours, or from 0.5 hours to 2 hours. Drying unit 144 can be used to produce, for example, finished iron oxide pigments (e.g., within stream 145), which can be collected and stored in unit 145A for future use.

In some embodiments, unit 146 can be present. Unit 146 can be coupled to (e.g., attached to) unit 141, in some embodiments. In some embodiments, unit 146 utilizes a heat exchanger to lower the temperature of the inlet gas and recycle the heat in unit 125. To scrub the off-gasses, in some embodiments, the effluent gas may pass through acidic (e.g., dilute inorganic acid) and basic (e.g., dilute ammonia) scrubbers. Unit 146 can be used to produce stream 147, which can contain oxygen, nitrogen, and water vapor gasses. Stream 147 can be stored as cleaned gas effluent in unit 147A for future use.

In some embodiments, the method further comprises extracting at least one rare earth metal from the leachate (e.g., stream 109 as shown in FIG. 1A) comprising the dissolved impurities. The dissolved impurities may include any of a variety of impurities described elsewhere herein, such as compounds containing an oxide, hydroxide, and/or oxyhydroxide (e.g., silicate, aluminate, titanate, and/or rare earth metal oxide or hydroxide, etc.), various salts (e.g., alkali and/or alkaline earth metal salts, etc.), and/or other impurities. In some embodiments, via the selective leaching, various residual impurities (e.g., compounds comprising alkali and/or alkaline earth metal salts, alumina, silica, and/or titania from the leachate via selective leaching) from the leachate may be recovered.

The method described herein may advantageously allow for extraction of rare earth metal compounds from other impurities. The extracted rare earth metal may be present in any of a variety of forms described elsewhere herein, including, but not limited to, an oxide, a hydroxide, an oxyhydroxide, a sulfide, a sulfate, an oxalate, a carbonate, a phosphate, and/or a salt. For example, in one set of embodiments, at least a portion (e.g., at least 20 wt %, at least 40 wt %, at least 60 wt %, or more, and/or up to 80 wt %, or up to 90 wt %, or more) of the extracted rare earth metal may be present in the form of rare earth metal oxides.

The extracting may be performed via a series of steps, such as via precipitation and selective leaching, according to some embodiments. For example, referring back to FIG. 1A, stream 109 (e.g., leachate stream containing dissolved impurities described elsewhere herein (e.g., silicate, aluminate, and/or rare earth metal hydroxide (REOH)) can be further processed. In some embodiments, content of stream 109 is precipitated using base (if from an acid digest) or acid (if from a basic digest), and then rare earth minerals are selectively leached from the precipitated solid using acid. According to some embodiments, the precipitated solid can be selectively leached to produce a leachate rich in rare-earth metal (relative to other impurities) and solids rich in other impurities (relative to rare-earth metal). For example, referring to FIG. 1C, content of stream 109 can be leached within unit 148 (using acid or base within stream 149) to produce a leachate (e.g., a rare-earth metal rich liquid) and solids (e.g., solids lean in rare-earth metal but rich in other impurities (e.g., compounds comprising alkali and/or alkaline earth metal salts, alumina, silica, and/or titania) within stream 150.

In some embodiments, the rare earth rich liquid and the solids (e.g., within stream 150) can be separated from each other using a solid-liquid separator. For example, in FIG. 1C, solid-liquid separator 151 can be used to produce stream 153 containing rare-earth rich liquid and residue stream 154 (e.g., solids comprising alumina, silica, and/or alkali/alkali-earth salts). The residual stream 154 can be collected and stored in unit 154A for future use. In some embodiments, a flocculant can be transported into unit 151 (e.g., via stream 152) to produce separation of components.

In some embodiments, a relatively high amount of rare earth metal compounds are leached from the precipitated solid and dissolved by the acid. For example, in some embodiments, at least 40 wt %, at least 50 wt %, at least 60 wt %, at least 70 wt %, at least 80 wt % at least 85 wt %, or at least 90 wt % (and/or up to 100 wt %) of rare earth compounds from the precipitated solid are dissolved into the rare-earth rich liquid.

In some embodiments, the rare earth rich liquid is further purified to remove selected impurities. The selected impurities, according to some embodiments, comprise actinides. In some such embodiments, the method further comprises recovering compounds comprising actinides from the leachate via scrubbing. For example, in certain embodiments, the rare earth rich liquid (e.g., within stream 153) is then scrubbed with ion exchange resins to remove other impurities (e.g., actinides (e.g., thorium and/or uranium), ferric species, aluminum species, and/or residual alkali/alkali-earth salts). For example, in FIG. 1C, ion exchange scrubber 155 (e.g., including an ion exchange resin such as Purolite) is used to remove the impurities (e.g., actinides, ferric species, aluminum species, and residual alkali/alkali-earth salts) from stream 153 to produce rare earth liquid stream 157 and residue stream 156 (e.g., containing aqueous actinides such as thorium, uranium, etc.). The residual stream can be collected and stored in unit 156A for future use. In some embodiments, 5 to 50 units (by volume) of leachate solution is transported through unit 155 per 1 unit volume of the ion exchange resin. Quaternary ammonium resins can be used, in certain embodiments, to recover actinide elements. Chelating resins can be used, in some embodiments, to remove dissolved iron and aluminum species. In some embodiments, the pH for unit 155 can be modified using reagent in stream 154, based on the resin requirements.

In some embodiments, the scrubber produces a mixed rare earth stream (e.g., stream 157) in which at least 75 wt %, at least 80 wt %, at least 85 wt %, at least 90 wt %, at least 95 wt %, or at least 99.9 wt % (and/or up to 100 wt %) of the liquid species in the stream are rare earth materials.

In certain embodiments, the rare earth liquid stream (e.g., stream 157) then proceeds through a solvent exchange loop to collect the rare earth metals. For example, in FIG. 1C, stream 157 is transported to solvent exchange loop 158. Unit 158 can receive stream 181, which can contain a pH adjusting reagent, typically either a strong acid or base to adjust the pH to the desired level prior to solvent extraction. Unit 158 can, in some embodiments, operate at an acid concentration of from 0.1 M to 12 M, from 0.25 M to 6 M, or from 0.5 M to 4 M. In some embodiments, unit 158 can be operated at a temperature of from 25° C. to 90° C., from 30° C. to 75° C., or from 35° C. to 60° C. The operation can be performed for 0.125 to 2 hours, for 0.2 to 1 hours, or for 0.25 hours to 0.5 hours. In some embodiments, the organic loading to acid ratio is from 0.25:1 to 4:1, from 0.5:1 to 3:1, or from 0.75:1 to 2:1. Potential lixiviants include, but are not limited to, D2EHPA, HEHEHP, and Cyanex style molecules. Unit 158 can produce stream 182, which can comprise organically loaded solvent, containing rare earth elements from the selected solvent lixiviant.

In some embodiments, stream 182 is transported to unit 160. Unit 160 can be a stripping and precipitation tank (which can, in some embodiments, be separated into two units). Stream 159, which is also fed to unit 160, can comprise acid (e.g., highly concentrated acid) to strip the rare earth loaded organic lixiviant. Stream 159 can also include, in some embodiments, a precipitating agent, carbon dioxide, ammonia, or other stabilizing agent. In some embodiments, the stripping solution for the solvent extraction has an acid concentration of from 1 M to 12 M, from 1.5 M to 8M, or from 2 M to 6 M. In some embodiments, the process is performed at a temperature of from 25° C. to 90° C., from 30° C. to 75° C., or from 35° C. to 60° C. The process can be performed, for example, for 0.125 hours to 2 hours, for 0.2 hours to 1 hours, or from 0.25hours to 0.5 hours. Precipitation can be caused by adding carbon dioxide, ammonia, or another stabilizing agent (or combinations of these), which can form highly stable rare earth compounds.

In some embodiments, the rare earth materials in solvent (e.g., within stream 161) are then stripped from the solvent and precipitated. For example, in FIG. 1C, stream 161 is transported to solid-liquid separator 162. Unit 162 can comprise, in some embodiments, a filter. In some embodiments, unit 162 comprises a clarifier. Unit 162 can be operated, in some embodiments, at ambient temperature. In some embodiments, unit 162 produces stream 163. Stream 163 can be used to recover liquid from unit 162 and recycle it back (optionally with stream 159) to be used in unit 160. Stream 163 can comprise, in some embodiments, primarily of slightly neutralized acid, with few dissolved metals. Unit 162 can also produce stream 164. Stream 164 can comprise the solid rare earth compounds that were precipitated earlier. In some embodiments, the solids within stream 164 have a moisture content of at least 15 wt %, at least 20 wt %, and/or up to 25 wt %, or up to 30 wt % (e.g., such as from 15 wt % to 30 wt %).

In some embodiments, the extracted solid rare earth compounds may be further processed to remove and/or separate one or more species of interest from the rest of the species. For example, it may be particularly advantageous to remove cerium from the extracted solid rare earth compounds, before further processing the rest of the rare earth compounds. As described in more detail below, the extracted solid rare earth compounds may be subjected to a series of processing steps, e.g., roasting, selective leaching, solid-liquid separation, and/or solvent loop extraction.

In some embodiments, the extracted solid rare earth compounds may be subjected to a roasting process. In certain embodiments, as shown in FIG. 1D, stream 164 is further processed. For example, in some embodiments, the concentrated rare earths (e.g., within stream 164) then undergo roasting. For example, in FIG. 1D, stream 164 is transported to roasting unit 165. In accordance with certain embodiments, unit 165 functions by roasting stream 164 at an elevated temperature. In some embodiments, the roasting unit is operated at a temperature of from 100° C. to 900° C., from 300° C. to 800° C., or from 400° C. to 650° C. In some embodiments, the roasting is performed for 1 to 8 hours, for 2 to 6 hours, or for 2.5 hours to 5 hours.

Unit 165 can produce stream 167, which can contain a mixture of off-gasses from the roasting process. Examples of gases that can be present include, but are not limited to, carbon dioxide, steam, ammonia, and nitrogen. The off-gasses may be further stored in unit 167A as cleaned gas effluent for future use. In some embodiments, these gasses are transported through a series of acidic (e.g., dilute inorganic acid) and basic (e.g., dilute ammonia) scrubbers.

In some embodiments, the roasted, solid rare earth oxides (e.g., within stream 166) then undergo selective leaching, for example, leaving cerium species undissolved. For example, in FIG. 1D, stream 166 can be transported to leaching unit 169. Stream 168, which can contain a strong acid such as a strong inorganic acid (e.g., sulfuric acid, nitric acid, perchloric acid, hydrochloric acid, or a mixture of these or other acids) can also be transported to unit 169. Unit 169 can be operated, in some embodiments, at a strong inorganic acid concentration of from 0.1to 12 M, from 0.25 to 6 M, or from 0.5 to 4 M. In some embodiments, unit 169 is operated at a temperature of from 25° C. to 90° C., from 30° C. to 85° C., or from 35° C. to 70° C. The process within unit 169 can be performed for 0.125 to 6 hours, for 0.5 to 5 hours, or for 1.5 to 4 hours. Unit 169 can be used to produce stream 170, which can comprise a solution of dissolved rare earth compounds, with a limited amount of or no cerium-based compounds. In some embodiments, the mixed rare earth stream loses at least 50 wt %, at least 60 wt %, at least 70 wt %, at least 75 wt %, at least 75 wt %, at least 85 wt %, or at least 95 wt % (and/or up to 100 wt %) of its cerium content.

In some embodiments, the selectively leached rare earths (e.g., within stream 170) then undergo a solid-liquid separation, removing the solid cerium. For example, referring to FIG. 1D, stream 170 is transported to solid-liquid separation unit 171. Unit 171 can comprise, in some embodiments, a filter. In some embodiments, unit 171 comprises a clarifier. Unit 171 can be operated, in some embodiments, at ambient temperature. Unit 171 can be used to produce stream 172, which can include a solid powder of fairly high purity cerium (e.g., greater than or equal to 95 wt % cerium). The high purity cerium may be stored in unit 172A for future use.

In some embodiments, the method further comprises at least partially separating the extracted rare earth metals into light rare earth metals and heavy rare earth metals via solvent extraction. In certain embodiments, the leached rare earth metals (e.g., within stream 173, which can contain a stream of mixed rare earth oxide compounds dissolved in acid) then undergo solvent extraction through loops, splitting the light and heavy rare earths in solution. For example, in FIG. 1D, stream 173 is transported to solvent exchange loop 174, which is used to produce stream 175 of light rare earth oxides and stream 176 of heavy rare earth oxides. As used herein, “light” rare earth elements are lanthanum (La), cerium (Ce), praseodymium (Pr), and neodymium (Nd), and “heavy” rare earth elements are the other rare earth elements (including scandium (Sc) and yttrium (Y) and the other rare earth elements (promethium (Pm), europium (Eu), gadolinium (Gd), samarium (Sm), dysprosium (Dy), terbium (Tb), holmium (Ho), erbium (Er), thulium (Tm), ytterbium (Yb), and lutetium (Lu)). In some embodiments, the rare earth materials within stream 173 are separated to produce a first stream (e.g., stream 175 in FIG. 1D) in which at least 50 wt %, at least 80 wt %, or at least 90 wt % (and/or up to 100 wt %) of the rare earth material is light rare earth material and a second stream (e.g., stream 176 in FIG. 1D) in which at least 10 wt %, at least 35 wt %, or at least 75 wt % (and/or up to 95 wt %) of the rare earth material is heavy rare earth material. In one set of embodiments, the extracted rare earth metals may be separated into a stream comprising predominantly (e.g., greater than 50 wt % or higher (and/or up to 100 wt %)) heavy rare earth metals and a stream comprising predominantly (e.g., greater than 50 wt % or higher (and/or up to 95 wt %)) light rare earth metals. The light rare earth metals in stream 175 and heavy rare earth metals in stream 176 may be separately stored in unit 175A and 176A, respectively.

Any of a variety of acids can be used in the above-referenced process steps that include an acid. In some embodiments, a strong acid (e.g., sulfuric acid, such as 98 wt % sulfuric acid, or hydrochloric acid, such as 37% hydrochloric acid) can be used.

Any of a variety of bases can be used in the above-referenced process steps that include caustic. In some embodiments, a strong base (e.g., sodium hydroxide, such as 99% sodium hydroxide) and/or ammonia (e.g., 5% ammonia solution) can be used. Any of a variety of reducing agents can be used in reduction steps described herein. For example, in some embodiments, hydrogen gas (e.g., 99% hydrogen gas), methane (e.g., 99% methane gas), and/or syngas (e.g., 99% syngas) can be used.

Any of a variety of solvent extractants can be used in the steps described herein. In some embodiments, the solvent extractant comprises Di-(2-ethylhexyl)phosphoric acid (D2EHPA, available from Sigma-Aldrich) and/or Cyanex 572 (available from BASF).

The systems and methods described herein can be used to efficiently produce recovered iron and other valorized products. In accordance with certain embodiments, it can be particularly advantageous to upgrade the iron prior to metallization of the iron. Also, in accordance with certain embodiments, it can be particularly advantageous to valorize components that have already been removed from the tailings. In existing methods, iron-rich materials are generally directly reduced. However, aluminosilicates and other impurities lead to incomplete conversion of the iron oxides to metallic iron, leaving residual iron oxide content. In addition, these aluminosilicates and alkali/alkali-earth elements slow down the conversion of iron oxides to metallic iron. To make the final product and the processing time more efficient, these impurities can be removed prior to the iron metallization step (e.g., chemically and/or physically). On top of that, these “gangue” materials can be valorized because they have been purified from the iron stream. By leveraging the small particle size and subsequent rapid kinetics, high quality streams of these materials will become available for sale, particularly rare earth oxides, alumina, silica, and mixed aluminosilicates.

As outlined above, the systems and methods described herein can be used to produce a variety of products. In some embodiments, the systems and methods can be used to produce reduced iron (e.g., directly reduced iron). In certain embodiments, the systems and methods described herein can be used to produce iron oxide-containing pigments. In some embodiments, the systems and methods described herein can be used to produce rare earth concentrate. In certain embodiments, the systems and methods described herein can be used to produce alumina, silica, and titania mixed material. In some embodiments, the systems and methods described herein can be used to produce sodium and calcium salts. In certain embodiments, the systems and methods described herein can be used to produce rare earth oxides (e.g., individual rare earth oxides or mixed rare earth oxides).

In each instance herein in which units, separators, and other equipment is described, the equipment can include one vessel or a plurality of vessels. In some embodiments in which a plurality of vessels are used within equipment, the vessels can be fluidically connected to each other (e.g., in parallel or in series) and may act together to perform the described function.

In various parts of the specification, streams are described. It should be understood that the term “stream” is used to refer to inputs and outputs from various units, and not all streams much necessarily include liquid or otherwise be flowable. In certain embodiments, it can be advantageous for various of the streams described in this specification to include a liquid and/or be flowable.

While FIG. 1A illustrates a set of embodiments in which the system comprises one or more iron reduction units (e.g., units 112 and/or 117) that are separate from the magnetic separator (e.g., unit 115), it should be understood that not all embodiments described herein are so limiting, and that in certain embodiments, the magnetic separator and at least one of the iron reduction units may be integrated into a single combined unit where both processes, e.g., the iron reduction and the magnetic separation, may be carried out within a single reactor.

For example, as shown in FIG. 1A, the system may comprise leaching unit 101 comprising a first reactor, where the first reactor comprising a first vessel configured such that, during operation, an iron-containing material within the first vessel is leached to produce solids (e.g., stream 110) comprising an iron-based material (e.g., iron-containing compound(s)) and a leachate (e.g., stream 109) comprising dissolved aluminosilicate and/or other impurities. The system may further comprise a magnetic separation unit (not shown) downstream of leaching unit 101. The magnetic separation unit, according to some embodiments, may be configured to operate as a combined iron-reduction unit (e.g., unit 112) and magnetic separator (e.g., unit 115).

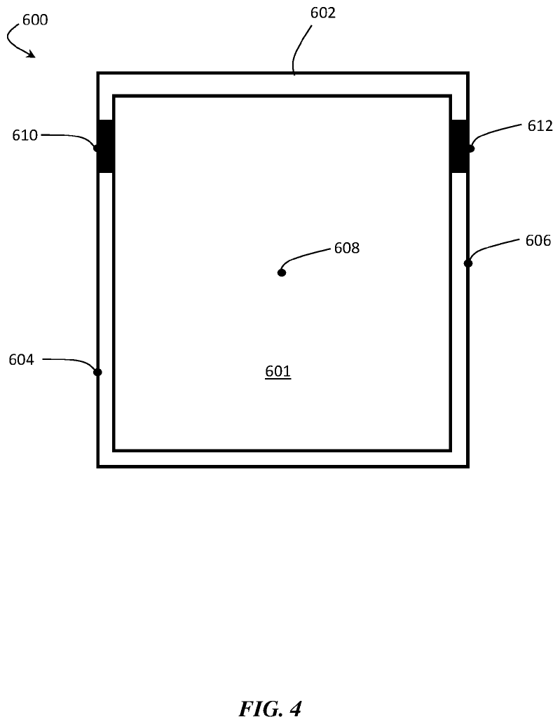

In some embodiments, the magnetic separation unit comprises a second reactor comprising a second vessel. The second vessel may be configured such that, during operation, at least a portion of the iron-containing compound in the solids (e.g., stream 110) is selectively reduced to a magnetically susceptible iron-containing material (e.g., magnetite) and subjected to magnetic separation, according to some embodiments. In certain embodiments, the iron reduction and the magnetic separation may be carried out simultaneously within the magnetic separation unit. Non-limiting examples of a reactor within the magnetic separation unit are shown in FIGS. 3A-4, as described in more detail below.

An illustrative reactor 30 configured for the recovery of relatively magnetically susceptible reaction products is shown in FIG. 3A. Reactor 30 of FIG. 3A comprises a vessel 35; a magnetic field source 32 at least partially within vessel 35; and a mixer 34 at least partially within vessel 35. Reactor 30 is configured such that, during operation, the iron reduction reaction products (e.g., magnetically susceptible iron-containing material (e.g., magnetite)) are selectively transported to magnetic field source 32, relative to the reactants (e.g., iron-containing compounds such as iron (III) oxide, hydroxide, and/or oxyhydroxide (e.g., hematite and/or goethite)).

Also discussed herein are systems and methods for recovering magnetically susceptible reaction products from reaction vessels. Examples of reaction products include but are not limited to magnetite, maghemite, and ilmenite. In one embodiment, the reactor produces, separates, and harvests magnetite (Fe₃O₄) through the reduction of hematite (Fe₂O₃) from bauxite tailings (e.g., with hydrazine or other chemistries, for example, in an aqueous environment). This may be performed, in some embodiments, by agitating the initial chemical mixture in a pressurized reactor at high temperatures (e.g., 250° C.-300° C.) so that the hematite reactant is reduced by the aqueous (e.g., comprising hydrazine, starch or rice straw) solution, forming magnetite.

In some embodiments, the systems and methods described herein do not involve a solid-state reaction to produce the reaction product. In certain embodiments, the temperature at which the reaction is conducted is relatively low (e.g., less than or equal to 500° C., less than or equal to 450° C., less than or equal to 400° C., less than or equal to 350° C., or lower). In some embodiments, in the systems and methods described herein, the reaction is run, at least partially, without the use of a reducing gas such as hydrogen. Operation of the system in this way may lead to reduction in cost, reduction in energy use, and/or enhancements in safety.

Alternatively, in some embodiments, the systems and method described herein involve a solid-state reaction to produce the reaction product, as described elsewhere herein. For example, in some such embodiments, one or more reducing gasses may be employed to in the reduction of solids comprising iron-based materials (e.g., iron-containing compound and/or elemental iron).

The presence of undesirable impurities in the initial reactant material (e.g., iron-containing materials (e.g., tailings, such as bauxite tailings, which may include, for example, aluminosilicates, salts, etc.)) may necessitate the separation and purification of the newly formed magnetically susceptible reaction product (e.g., magnetite) to make it commercially feasible. Accordingly, in some embodiments, magnetic separation may be used to separate reaction product from other materials in the reactor. As one example, magnetic separation may be used to separate a magnetite product. Magnetite is substantially more ferromagnetic than hematite (to the extent hematite can be considered ferromagnetic at all) and/or other iron (III) oxides, hydroxides, and/or oxyhydroxides described elsewhere herein, and accordingly, magnetite may be manipulated through the application of a magnetic field. This may be performed, for example, by dispersing the magnetite mixture in liquid (e.g., water). Through additional mixing and magnetic separation of this slurry, the magnetite may be isolated and extracted.

Certain embodiments of the instant reactor incorporate a chemical reaction (e.g., reduction of hematite), optional dissolution of soluble impurities, and selective separation and extraction of the reaction product (e.g., magnetite) in a single vessel (e.g., aqueous environment). In some such embodiments, the systems and methods described herein may be operated continuously. In some embodiments, the reaction and separation steps may be operated over overlapping periods of time.

Certain embodiments of the instant reactor dramatically simplify the overall process workflow by amalgamating the chemical reaction (e.g., reduction reaction) and magnetic separation steps and confining them in the same vessel (e.g., aqueous environment). The reactor may employ, in accordance with certain embodiments, safe operating conditions without the need for costly and potentially hazardous chemical reagents.

In certain embodiments, the chemical reaction (e.g., reduction reaction of hematite) and the magnetic separation and/or extraction of the formed reaction product (e.g., magnetite) is performed within a single, continuously operated volume. In some embodiments, these two steps are performed within the same liquid. The assimilation of these two steps in the same liquid (e.g., aqueous) environment may facilitate a more streamlined process without the need for an additional hazardous, energy intensive, and expensive solid-state reaction (e.g., reduction of leached bauxite residue) prior to magnetic separation of the reaction product (e.g., magnetite).

A variety of reducing agents may be used. In some embodiments, akaganéite (β-FeOOH) nanorods may be converted into magnetite (Fe₃O₄) through a reduction reaction in the presence of hydrazine at ambient conditions. In some embodiments, iron oxide is reduced with rice straw, for example, using a high-pressure hydrothermal method. For example, in high-iron red mud, starch may be used as the reducing agent to reduce Fe₂O₃ (hematite) to form Fe₃O₄ (magnetite).

As noted above, certain aspects are related to reactors. The reactors may be used to recover relatively magnetically susceptible reaction products. FIGS. 3A-3B are cross sectional schematic illustrations of examples of such reactors (e.g., reactor 30).

In certain embodiments, the reactor comprises a vessel. In some embodiments, the reactor further comprises baffles within the vessel associated with one or more walls of the vessel. The baffles may redirect the flow of liquid in the vessel as it is mixed (e.g., by a mixer) so that settling at the bottom of the vessel is avoided. A reactor may further comprise a liquid in the vessel. In certain embodiments, the liquid contains hematite as a reactant and magnetite as a reaction product. In some embodiments, the liquid comprises (e.g., consists of) an aqueous solution. In certain embodiments, the aqueous solution comprises hydrazine, starch, rice straw, and/or rice hulls. In certain embodiments, the aqueous solution comprises hydrazine. In certain embodiments, the aqueous solution comprises hematite as a reactant. In certain embodiments, a solid-state reaction may be carried out employing one or more reducing gasses.

In certain embodiments, the reactor comprises a magnetic field source at least partially within the vessel. The reactor may be configured such that, during operation, the reaction products are selectively transported to the magnetic field source, relative to the reactants. In some embodiments, the magnetic field source is positioned proximate an outlet of the vessel. The magnetic field source may comprise a magnetic filter, such as a magnetic cage. Other examples of magnetic field sources include but are not limited to a magnetic belt, a magnetized conveyor, an electromagnet, a permanent magnet, a pressure-driven magnetic separator (e.g., a tube including a magnetic grate), etc. Hematite and magnetite may be the reactant and reaction product, respectively. Hematite and magnetite may have a different magnetic susceptibility, such that the magnetic field source may exert a field large enough to attract the magnetite but not so large as to attract the hematite.

In certain embodiments, the reactor comprises a mixer at least partially within the vessel. In certain embodiments, the mixer and the magnetic field source act in concert to selectively transport reaction product to the magnetic field source. In such embodiments, the selective transport may in part be due to the higher magnetic susceptibility of the reaction product relative to that of the reactant and may in part be due to controlling the flow of the liquid within the reactor. The mixer may comprise, e.g., an impeller, a stir bar, a rotating blade, and/or any other suitable mixer. The impeller may be configured to be magnetically stirred and/or may be configured to collect reaction product.

The reactor may comprise a pump configured to create a pressure drop resulting in the transport of liquid comprising reactant into the vessel. The pump may be, e.g., a positive pressure pump (e.g., connected to a liquid) or a vacuum pump (e.g., connected to an outlet). The reactor may comprise a pump configured to remove reaction product (e.g., liquid comprising reaction product) from the vessel. To accomplish flow of matter through the system, a pressure gradient may be established by, e.g., pumping a reactant feed entering the vessel, and/or pulling suction on an outlet of the vessel.

The pressure differential may be, e.g., at least 0.1 atm, at least 1 atm, or at least 10 atm. The pressure differential may be, e.g., at most 70 atm, at most 60 atm, or at most 50 atm. Combinations of these ranges are also possible (e.g., at least 0.1 atm and at most 70 atm, at least 1 atm and at most 60 atm, at least 10 atm and at most 50 atm). Other ranges are also possible.

In certain embodiments, some or all mechanical elements of this system comprise (e.g., consist of) stainless steel (e.g., 304, 316, etc.). Stainless steel may, e.g., prevent corrosion from an input bauxite residue slurry, which may be caustic from an upstream leaching process. Stainless steel may also safely maintain the structural integrity of the reactor vessel under the required pressure and temperature conditions. The seals (e.g., shaft seals, O-rings, and lid gaskets) of the reactor vessel may comprise (e.g., consist of) PTFE, which may be non-reactive and durable to the internal conditions of the vessel. The vessel may be heated externally through resistive coils (e.g., comprising or consisting of Inconel® etc.). In some embodiments, the vessel may be insulated (e.g., with aluminosilicate fibers) to minimize thermal losses and ensure operator safety.

In certain embodiments, one or more components of the system (e.g., the vessel, the magnetic field source, or any other components of the system, optional or otherwise) may be thermally insulated. The use of thermally insulated components may be particularly useful when high temperature operation (which can be useful when processing or otherwise handling magnetic products) is desired. In some embodiments, the interior of the container is substantially surrounded (e.g., at least 50% surrounded, at least 70% surrounded, at least 80% surrounded, at least 90% surrounded, at least 98% surrounded, or 100% surrounded) by thermally insulating solid material. The thermally insulating solid material may have, for example, a thermal conductivity of less than or equal to 10 W/mK at 25° C., less than or equal to 1 W/mK at 25° C., or less than or equal to 0.1 W/mK at 25° C. To determine whether the interior of a container is “at least 50% surrounded” by thermally insulating solid material, one would: (1) locate the geometric center of the interior of the container; (2) for each location on the outer boundary of the container, establish a straight line from the geometric center of the interior of the container to that location on the outer boundary of the container; and (3) calculate the percentage of the straight lines that pass through thermally insulating solid material. If the result of Step 3 is at least 50%, then the interior of the container would be said to be at least 50% surrounded by thermally insulating solid material. A similar calculation may be performed to determine whether a container is surrounded by thermally insulating solid material to any other degree (e.g., at least 70% surrounded by, at least 80% surrounded by, etc.). One example of this calculation may be described in relation to FIG. 4. In FIG. 4, container 600 is made of both thermally insulating material (shown in white in the figure) and thermally conducting material (shown in black in the figure). Interior 601 of container 600 in FIG. 4 is at least 50% surrounded by thermally insulating solid material because 50% or more of the locations on the outer boundary 602 of container 600 (including locations 604 and 606) have thermally insulating solid material positioned between those locations and geometric center 608 of container 600. (In contrast, locations 610 and 612 do not have thermally insulating solid material positioned between them and geometric center 608 of container 600.)

Examples of thermally insulating solid materials that may be used to make at least a portion of (e.g., at least 50 vol % of, at least 75 vol % of, at least 90 vol % of, at least 95 vol % of, at least 99 vol % of, or more of) a container include, but are not limited to, metal oxides, metal nitrides, metalloid oxides, and metalloid nitrides. Specific examples of thermally insulating solid materials that may be used to make at least a portion of (e.g., at least 50 vol % of, at least 75 vol % of, at least 90 vol % of, at least 95 vol % of, at least 99 vol % of, or more of) a container include, but are not limited to, concrete, glasses, ceramics, and/or cermets.

The magnetic separator may be driven by a pump, and the magnetization may be driven actively through pulsed electromagnets or passively through arrays of strong permanent magnets. Filters may comprise or consist of glass or other materials to prevent the unwanted collection of oxide particles in the effluent exhaust or recycling stream.

As noted above, certain aspects are related to methods. The methods may be used to generate and recover relatively magnetically susceptible reaction products, in certain embodiments. FIGS. 3A-3B are cross sectional schematic illustrations of examples of reactors (e.g., reactor 30) that may be used for such methods.

In certain embodiments, the method comprises carrying out, in a vessel, a chemical reaction in which a product of the chemical reaction has a greater magnetic susceptibility than a reactant of the chemical reaction.

The chemical reaction may be carried out in a liquid. In certain embodiments, the liquid comprises (e.g., consists of) an aqueous solution. In certain embodiments, the reactant is hematite and the product is magnetite. In some embodiments, carrying out the chemical reaction comprises stirring the liquid. Stirring the liquid may comprise, e.g., rotating an impeller in the vessel.

In some embodiments, the chemical reaction is carried out at a temperature of greater than or equal to 60 degrees Celsius, greater than or equal to 80 degrees Celsius, greater than or equal to 100 degrees Celsius, or greater than or equal to 200 degrees Celsius. In some embodiments, the chemical reaction is carried out at a temperature of less than or equal to 500 degrees Celsius, less than or equal to 400 degrees Celsius, or less than or equal to 300 degrees Celsius. Combinations of the above-referenced ranges are also possible (e.g., greater than or equal to 60 degrees Celsius and less than or equal to 500 degrees Celsius, greater than or equal to 200 degrees Celsius and less than or equal to 400 degrees Celsius, greater than or equal to 100 degrees Celsius and less than or equal to 300 degrees Celsius). Other ranges are also possible. In certain embodiments, the chemical reaction is carried out at a temperature of greater than or equal to 60 degrees Celsius and less than or equal to 500 degrees Celsius. In certain embodiments, the chemical reaction is carried out at a temperature of greater than or equal to 200 degrees Celsius and less than or equal to 400 degrees Celsius. x

In certain embodiments, the method comprises, simultaneously to carrying out the chemical reaction, effecting, in the vessel, a separation between the product and the reactant with a magnetic field source.

In some embodiments, the method further comprises retrieving the product from the magnetic field source in the vessel through an outlet of the vessel. In certain embodiments, retrieving the product from the magnetic field source comprises flowing a liquid comprising the product through the magnetic field source and out of the vessel through an outlet of the vessel. In certain embodiments, retrieving the product from the magnetic field source comprises pumping a liquid comprising the product through the magnetic field source and out of the vessel through an outlet of the vessel. In certain embodiments, retrieving the product through the outlet comprises filtering or discarding the effluent from the vessel and re-routing residual reactant (e.g., hematite) back into the vessel so that it may react.

In some embodiments, the method further comprises flowing a liquid comprising the reactant into the vessel through an inlet of the vessel. In some embodiments, the method comprises pumping a liquid comprising the reactant into the vessel through an inlet of the vessel. In certain embodiments, the liquid entering the vessel comprises hematite, water, and a reducing agent (e.g., starch, hydrazine, rice straw).

In certain embodiments, continuous operation is achieved by adjusting underflow or overflow through an inlet and outlet of the vessel depending on the kinetics of the chemical reaction. In some embodiments, this could be accomplished by placing a load sensor on the magnetic field source (e.g., magnetic accumulator). In some embodiments, upon reaching a predetermined amount (e.g., a fixed amount) of reaction product (e.g., newly created magnetic material) after a certain amount (e.g., a fixed amount) of reaction time, a quantity (e.g., fixed quantity) of underflow (e.g., aqueous solution) is pumped out of the reactor and the reaction product (e.g., magnetic material) is harvested through an airlock. In some embodiments, once the reaction product (e.g., magnetic material) is removed, new slurry enters the reactor through the inlet and a new magnetic field source (e.g., magnetic collector) may be inserted, starting the process again.

In certain embodiments, the reactor operates as an actively stirred, externally heated, and pressurized vessel, wherein a first reactant (e.g., hematite powder from bauxite residue), a liquid (e.g., water), and a second reactant (e.g., dissolved reducing agent(s)) are mixed and externally heated to a high temperature (e.g., 250° C.-300° C.). To drive this reaction, in certain embodiments, the reactant (e.g., hematite) is strongly agitated within the reducing solution, thereby facilitating formation of the reaction product (e.g., facilitating the transfer of ions to form magnetite). In certain embodiments, extent of agitation is reflected in the mixer speed, which may be in the range of, e.g., 10 RPM to 500 RPM. In one embodiment, because hematite and magnetite are denser than water and insoluble, they might naturally settle to the bottom of the vessel, which would retard the reduction reaction. However, in certain embodiments, a circumferential pattern of baffled indents along the inner wall of the reactor configured to passively redirect the flow upward and induce recirculation of the liquid (e.g., aqueous solution) as it is actively stirred by a central mixer.

In some embodiments, the mixer speed may be at least 10 RPM, at least 50 RPM, or at least 100 RPM. In some embodiments, the mixer speed may be at most 500 RPM, at most 400 RPM, or at most 300 RPM. Combinations of the above-referenced ranges are also possible (e.g., at least 10 RPM and at most 500 RPM, at least 50 RPM and at most 400 RPM, at least 100 RPM and at most 300 RPM). Other ranges are also possible.

In certain embodiments, a module housed within the pressurized reactor vessel actively pumps the reacting solution through a staged magnetic separator and filter. In certain embodiments, the magnetic separator locally applies a strong magnetic field (e.g., permanent magnet(s), electromagnet) that induces the reaction product (e.g., magnetite) particles to be forced out of the remaining flow of reactant (e.g., hematite) solution (e.g., attractive forcing, repulsive forcing). This may require more than one repetition or stage to filter out the residual reactant (e.g., hematite) sediment to acceptable levels and redirect the reactant (e.g., hematite) back to the mixer section of the vessel where it may proceed to react fully. The remaining product (e.g., magnetite) slurry may need to be filtered to remove the remaining effluent of liquid (e.g., water), second reactant (e.g., reducing agents), and soluble impurities. The recycling of the effluent may be instrumental in the continuous operation of this system, assuming the impurities can be removed and the remaining reducing agent can be recycled. The separated and extracted reaction product (e.g., magnetite) may then move on to the next stage of the upstream process flow, where it may be collected, dried, and/or further reacted (e.g., reduced fully to directly reduced iron (DRI)).

The magnetic field locally applied by the magnetic separator may be, e.g., at least 0.1 Tesla, at least 0.5 Tesla, or at least 0.75 Tesla. The magnetic field locally applied by the magnetic separator may be, e.g., at most 1.5 Tesla, at most 1.25 Tesla, or at most 1 Tesla. Combinations of the above-referenced ranges are also possible (e.g., at least 0.1 Tesla and at most 1.5 Tesla, at least 0.5 Tesla and at most 1.25 Tesla, at least 0.75 Tesla and at most 1 Tesla). Other ranges are also possible.

An illustrative reactor 30 configured for the recovery of relatively magnetically susceptible reaction products is shown in FIG. 3A. Reactor 30 of FIG. 3A comprises a vessel 35; a magnetic field source 32 at least partially within vessel 35; and a mixer 34 at least partially within vessel 35. Reactor 30 is configured such that, during operation, the reaction products are selectively transported to magnetic field source 32, relative to the reactants.

An illustrative reactor 200 configured for the recovery of relatively magnetically susceptible reaction products is shown in FIG. 3B. Reactor 200 of FIG. 3B comprises a vessel 215; a magnetic field source 202 at least partially within vessel 215; and a mixer 214 at least partially within vessel 215. Reactor 200 is configured such that, during operation, the reaction products are selectively transported to magnetic field source 202, relative to the reactants. Reactor 200 comprises an inlet 206 through which reactant (e.g., liquid comprising reactant) may flow into vessel 215 in the direction indicated by a dashed arrow. Reactor 200 comprises a lid 204 (e.g., a high-pressure lid configured to withstand pressures from 101,000 Pa to 7,000,000 Pa) of vessel 215. Reactor 200 further comprises baffles 210 within vessel 215 associated with one or more walls 216 of vessel 215. Mixer 214 comprises an impeller. The impeller may rotate as indicated by a dashed arrow. Baffles 210 and impeller 214 may work together to direct the flow of liquid in the reactor as indicated by dashed-dot arrows. Reactor 200 comprises heating elements 212 configured for heating vessel 215 to a reaction temperature. Magnetic field source 202 comprises magnetizing element 201 and magnetic cage 203. Reactor 200 comprises an outlet 208 through which reaction product (e.g., liquid comprising reaction product) may flow out of vessel 215 in the direction indicated by a dashed arrow.

The high-pressure lid may be configured to withstand pressures of at least 101,000 Pa, at least 500,000 Pa, at least 3,000,000 Pa, or at least 5,000,000 Pa. The high-pressure lid may be configured to withstand pressures of less than or equal to 7,000,000 Pa, less than or equal to 5,000,000 Pa, or less than or equal to 1,000,000 Pa. Combinations of the above-referenced ranges are also possible (e.g., at least 101,000 Pa and less than or equal to 7,000,000 Pa, at least 200,000 Pa and less than or equal to 5,000,000 Pa, at least 300,000 Pa and less than or equal to 1,000,000 Pa). Other ranges are also possible.

An illustrative portion 300 of a reactor configured for the recovery of relatively magnetically susceptible reaction products is shown in FIG. 3C. A magnetizing element 301 and a magnetic cage 303 may work with other components of the reactor to selectively collect reaction product relative to reactant, which reaction product may then be transported out of the vessel through outlet 308 incorporated into a vessel wall 316.

An illustrative portion 400 of a reactor configured for the recovery of relatively magnetically susceptible reaction products is shown in FIG. 3D. A magnetic filter 402 separating an outlet 408 from the remainder of the vessel may work with other components of the reactor to selectively collect reaction product relative to reactant, which reaction product may then be transported out of the vessel through outlet 408 incorporated into a vessel wall 416.

In one embodiment, a method comprises: carrying out, in vessel 35, a chemical reaction in which a product of the chemical reaction has a greater magnetic susceptibility than a reactant of the chemical reaction; and simultaneously effecting, in vessel 35, a separation between the product and the reactant with a magnetic field source 32. The chemical reaction may be carried out in a liquid. Carrying out the chemical reaction may comprise stirring the liquid using mixer 34.

In one embodiment, a method comprises: carrying out, in vessel 215, a chemical reaction in which a product of the chemical reaction has a greater magnetic susceptibility than a reactant of the chemical reaction; and simultaneously effecting, in vessel 215, a separation between the product and the reactant with a magnetic field source 202 comprising magnetic cage 203. The chemical reaction may be carried out in a liquid. Carrying out the chemical reaction may comprise stirring the liquid using impeller 214.

In some embodiments, the systems described herein may be used to produce a system product that contains a relatively large amount of the magnetically susceptible reaction product (e.g., on an absolute basis and/or relative to an amount of unreacted reactant material of the type used to make the magnetically susceptible reaction product).

For example, in some embodiments, at least 50 wt %, at least 75 wt %, at least 90 wt %, at least 95 wt %, at least 99 wt %, at least 99.9 wt %, at least 99.99 wt %, at least 99.999 wt %, at least 99.9999 wt %, or more of the system product (e.g., the material collected via the magnetic field source) is made of the magnetically susceptible reaction product.

In some embodiments, within the system product, the ratio of the mass of magnetically susceptible reaction product to the mass of at least one reactant used to make the magnetically susceptible reaction product is at least 1:1, at least 2:1, at least 3:1, at least 4:1, at least 5:1, at least 10:1, at least 25:1, at least 50:1, at least 100:1, at least 500:1, at least 1000:1, at least 1×10⁵:1, at least 1×10⁶:1, at least 1×10⁷:1, at least 1×10⁸:1, or more. In some embodiments, within the system product, the ratio of the mass of magnetically susceptible reaction product to the total mass of reactant material of the type used to make the magnetically susceptible reaction product is at least 1:1, at least 2:1, at least 3:1, at least 4:1, at least 5:1, at least 10:1, at least 25:1, at least 50:1, at least 100:1, at least 500:1, at least 1000:1, at least 1×10⁵:1, at least 1×10⁶:1, at least 1×10⁷:1, at least 1×10⁸:1, or more.

In some embodiments, a relatively large amount of the magnetically susceptible reaction product that is produced in the reactor is collected as a system product (e.g., via the magnetic field source). In certain embodiments, at least 50 wt %, at least 75 wt %, at least 90 wt %, at least 95 wt %, at least 99 wt %, at least 99.9 wt %, at least 99.99 wt %, at least 99.999 wt %, at least 99.9999 wt %, or more of the magnetically susceptible reaction product that is produced via the reaction within the reactor is collected as a system product.

In some embodiments, the extent of reaction of the reaction performed in the reactor to generate the magnetically susceptible reaction product is relatively high. For example, in some embodiments, the extent of reaction of the reaction performed in the reactor to generate the magnetically susceptible reaction product is at least 50%, at least 75%, at least 90%, at least 95%, at least 99%, at least 99.9%, at least 99.99%, at least 99.999%, at least 99.9999%, or more. In this context, the extent of reaction refers to the percentage of moles of the stoichiometrically-limited reactant that are reacted in the reaction. As an example, if A reacts with B in a reaction to produce C, and A is present in stoichiometric excess, an extent of reaction of 50% would be achieved if 50% of the moles of B react with A to produce product C.

In some embodiments, the magnetically susceptible reaction product may have a magnetic susceptibility with a relatively high absolute value. According to certain embodiments, the magnetically susceptible reaction product has a non-dimensional magnetic volume susceptibility (as defined in the International System of Units) having an absolute value of at least about 0.001, at least about 0.01, at least about 0.1, or at least about 1 (and/or, in some embodiments, up to about 10, up to about 20, or more). In some embodiments, the magnetically susceptible reaction product is paramagnetic (e.g., having a non-dimensional magnetic volume susceptibility of at least about 0.001, at least about 0.01, at least about 0.1, or at least about 1 (and/or, in some embodiments, up to about 10, up to about 20, or more)). In some embodiments, the difference between the magnetic volume susceptibility of the magnetically susceptible reaction product and the magnetic volume susceptibility of at least one reactant of the type used to make the magnetically susceptible reaction product is at least about 0.001, at least about 0.01, at least about 0.1, or at least about 1 (and/or, in some embodiments, up to about 10, up to about 20, or more). In some embodiments, the difference between the magnetic volume susceptibility of the magnetically susceptible reaction product and the magnetic volume susceptibility of each of the reactants of the type used to make the magnetically susceptible reaction product is at least about 0.001, at least about 0.01, at least about 0.1, or at least about 1 (and/or, in some embodiments, up to about 10, up to about 20, or more).

U.S. Provisional Patent Application No. 63/342,003, filed May 13, 2022, entitled “Extraction of Elements and/or Compounds from Iron-Containing Materials such as Iron-Containing Tailings and Related Systems and Products,” and U.S. Provisional Patent Application No. 63/405,077, filed Sep. 9, 2022, entitled, “Reactors and Methods for Recovery of Magnetically Susceptible Materials,” are each incorporated herein by reference in their entirety for all purposes.

The following examples are intended to illustrate certain embodiments of the present invention, but do not exemplify the full scope of the invention.

### Example 1

Bauxite residue and starch were mixed in at 48 grams and 12 grams respectively with excess sodium hydroxide solution into a pressure vessel having a magnetically stirred impeller. The system was allowed to reach a temperature of 300 degrees Celsius for 4 hours. After reacting, the vessel was opened, and magnetite was removed from the magnetically stirred impeller. High magnetite recovery was achieved.

### Example 2

25 grams of high aluminosilicate bauxite residue was put into a reactor with 75 grams of distilled water. 6.25 grams of sodium hydroxide was added to the reactor and mixed with the water and bauxite residue. The reactor was closed and mixing was started. The reactor was heated to 175° C. and held at that temperature for 1 hour. After digestion, the reactor was cooled and opened. The solids were then separated from the leachate. After separation, the solids were put into a furnace, heated up to 475° C., and exposed to 1 SCFH hydrogen gas for 1.5 hour. The solids were then cooled, and run through a magnetic separator to increase the iron content of magnetite rich materials. After magnetic separation, the magnetite was put into a furnace, heated to 425° C., and exposed to 1 SCFH of pure hydrogen. This process resulted in the conversion of magnetite into DRI (directly reduced iron).

### Example 3

20 grams of high calcium content bauxite residue were mixed with 80 grams of 7M hydrochloric acid. The system was mixed and heated to 75° C. for 1.5 hours. After digestion, the solids were separated from the leachate. The solids were then put into a furnace, heated up to 475° C., and exposed to 1 SCFH hydrogen gas for 1.5 hours. The solids were then cooled, and run through a magnetic separator to increase the iron content of magnetite rich materials. After magnetic separation, the magnetite was put into a furnace, heated to 425° C., and exposed to 1 SCFH of pure hydrogen. This process resulted in the conversion of magnetite into DRI (directly reduced iron).

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, “wt %” is an abbreviation of weight percentage. As used herein, “at %” is an abbreviation of atomic percentage. Unless context indicates to the contrary, the amounts described herein are based on mass and the percentage amounts described herein are based on mass percentages.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the 10 like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method for extracting iron from an iron-containing material, comprising:
leaching the iron-containing material to produce solids comprising an iron-containing compound and a leachate comprising dissolved aluminosilicate and/or other impurities; and
reducing the iron-containing compound to metallic iron.

2. The method of claim 1, wherein the iron-containing compound comprises an oxide, hydroxide, and/or oxyhydroxide of iron.

3. The method of any one of claims 1-2, wherein the iron-containing compound comprises hematite, magnetite, and/or goethite.

4. The method of any one of claims 1-3, further comprising, prior to the reducing, subjecting the iron-containing compound to magnetic separation.

5. The method of any one of claims 1-4, wherein the reducing comprises a first step of reducing the iron-containing compound to magnetite prior to a second step of reducing the magnetite to metallic iron.

6. The method of claim 5, further comprising magnetically separating the magnetite from the solids prior to the second step.

7. The method of any one of claims 1-6, wherein a mass fraction of the iron-containing compound relative to the sum of the iron-containing compound and the aluminosilicate and/or other impurities in the solids is greater than the mass fraction of the iron-containing compound relative to the sum of the iron-containing compound and the aluminosilicate and/or other impurities in the iron-containing material.

8. The method of any one of claims 1-7, wherein a mass fraction of the aluminosilicate and/or other impurities relative to the sum of the iron-containing compound and the aluminosilicate and/or other impurities in the leachate is greater than the mass fraction of the aluminosilicate and/or other impurities relative to the sum of the iron-containing compound and the aluminosilicate and/or other impurities in the iron-containing material.

9. A method for extracting iron from an iron-containing material, comprising:
leaching the iron-containing material to produce solids comprising hematite and/or goethite and a leachate comprising dissolved aluminosilicate and/or other impurities;
reducing the solids such that a magnetite-rich stream is produced; and
subjecting the magnetite-rich stream to magnetic separation such that a stream that is further enriched in magnetite compared to the magnetite-rich stream is produced.

10. The method of claim 9, further comprising reducing the stream that is further enriched in magnetite to metallic iron.

11. The method of any one of claims 1-10, wherein the iron-containing material comprises mining tailings, bauxite residues, sodalite, phyllosilicate, and/or iron slimes.

12. The method of any one of claims 1-11, wherein the impurities comprise an oxide, a sulfide, a sulfate, an oxalate, a carbonate, a phosphate, and/or a salt.

13. The method of any one of claims 1-12, wherein the impurities comprise a compound containing an alkali metal, an alkaline earth metal, a rare earth metal, a transition metal, a post-transition metal, and/or a metalloid.

14. The method of claim 13, wherein the post-transition metal comprises aluminum and/or gallium.

15. The method of any one of claims 13-14, wherein the metalloid comprises silicon and/or germanium.

16. The method of any one of claims 1-15, further comprising roasting the iron-containing material prior to the leaching.

17. The method of any one of claims 1-16, wherein, when a mass ratio of the total amount of alkali metal and/or alkaline earth metal relative to the total amount of metals that are not alkali or alkaline earth metal is greater than 1:6 in the iron-containing material, the leaching comprises acid leaching.

18. The method of claim 17, wherein the leaching comprises selectively leaching one or more compounds comprising an alkali metal, an alkaline earth metal, and/or a rare earth metal from the iron-containing material.

19. The method of any one of claims 17-18, wherein the acid leaching is carried out at a pH of less than 1.

20. The method of any one of claims 17-19, wherein the acid leaching is carried out at a temperature of greater than 50° C. and less than 100° C.

21. The method of any one of claims 1-16, wherein, when a mass ratio of the total amount of alkali metal and/or alkaline earth metal relative to the total amount of metals that are not alkali or alkaline earth metal is less than 1:10 in the iron-containing material, the leaching comprises caustic leaching.

22. The method of claim 21, wherein the leaching comprises selectively leaching one or more compounds comprising an alkali metal, aluminum, silicon, and/or a rare earth metal from the iron-containing material.

23. The method of any one of claims 21-22, wherein the caustic leaching is carried out at a pH of greater than 12.

24. The method of any one of claims 21-23, wherein the caustic leaching is carried out at a temperature of greater than 50° C. and up to 300° C.

25. The method of any one of claims 1-24, wherein the reducing comprises exposing the solids to a reducing gas comprising hydrogen, syngas, and/or methane.

26. The method of any one of claims 1-25, further comprising at least partially separating the leachate and the solids prior to the reducing.

27. The method of any one of claims 1-26, wherein the reducing is carried out at a temperature of greater than or equal to 300° C. and less than or equal to 650° C.

28. The method of any one of claims 1-27, wherein the metallic iron has a purity of at least 90%.

29. The method of any one of claims 1-28, further comprising producing iron oxide pigments from residual iron-containing material produced by the magnetic separation.

30. The method of any one of claims 1-29, further comprising extracting at least one rare earth metal from the leachate via precipitation and selective leaching.

31. The method of claim 30, further comprising at least partially separating the extracted rare earth metals into light rare earth metals and heavy rare earth metals via solvent extraction.

32. The method of any one of claims 1-31, further comprising recovering compounds comprising alkali and/or alkaline earth metal salts, alumina, silica, and/or titania from the leachate via selective leaching.

33. The method of any one of claims 1-32, further comprising recovering compounds comprising actinides from the leachate via scrubbing.

34. A system, comprising:
a leaching unit comprising a first reactor, wherein the first reactor comprises a first vessel configured such that, during operation, an iron-containing material within the first vessel is leached to produce solids comprising an iron-containing compound and a leachate comprising dissolved aluminosilicate and/or other impurities;
a solid-liquid separator fluidically connected to an outlet of the first reactor, wherein the solid-liquid separator is configured to separate the solids from the leachate; and
an iron reduction unit comprising a second reactor, wherein the second reactor is fluidically connected to an outlet of the solid-liquid separator and comprising a second vessel, wherein the second vessel is configured to reduce the iron-containing compound in the solids to a magnetically susceptible iron-containing material.

35. The system of claim 34, further comprising a magnetic separator fluidically connected to an outlet of the second reactor, wherein the magnetic separator is configured to magnetically separate the magnetically susceptible iron-containing material from the solids.

36. The system of claim 35, further comprising an additional iron reduction unit comprising a third reactor, wherein the third reactor is fluidically connected to an outlet of the magnetic separator and comprising a third vessel, wherein the third vessel is configured such that, during operation, the magnetically susceptible iron-containing material is reduced to metallic iron.

37. The system of any one of claims 34-36, further comprising a gaseous source comprising one or more reducing gases and fluidically connected to an inlet of the second reactor and/or the third reactor.

38. The system of any one of claims 34-37, further comprising a heat exchanger and/or a gas scrubber fluidically connected to an outlet of the second reactor and/or the third reactor.

39. The system of any one of claims 34-38, further comprising a source of iron-containing material and a source of leaching agent fluidically connected to one or more inlets of the first reactor.

40. A system, comprising:
a leaching unit comprising a first reactor, wherein the first reactor comprising a first vessel configured such that, during operation, an iron-containing material within the first vessel is leached to produce solids comprising an iron-containing compound and a leachate comprising dissolved aluminosilicate and/or other impurities; and
a magnetic separation unit comprising a second reactor, wherein the second reactor comprises a second vessel configured such that, during operation, the iron-containing compound in the solids is selectively reduced to a magnetically susceptible iron-containing material and subjected to magnetic separation.

41. The system of claim 40, the second reactor comprising:
a magnetic field source at least partially within the vessel; and
a mixer at least partially within the vessel;
wherein the second reactor is configured such that, during operation, the magnetically susceptible iron-containing material is selectively transported to the magnetic field source, relative to the iron-containing compound.

42. A reactor comprising:
a vessel;
a magnetic field source at least partially within the vessel; and
a mixer at least partially within the vessel;
wherein the reactor is configured such that, during operation, the reaction products are selectively transported to the magnetic field source, relative to the reactants.

43. The reactor of claim 42, further comprising baffles within the vessel associated with one or more walls of the vessel.

44. The reactor of any one of claims 42-43, further comprising a liquid in the vessel.

45. The reactor of claim 44, wherein the liquid contains hematite as a reactant and magnetite as a reaction product.

46. The reactor of any one of claims 42-45, wherein the liquid comprises an aqueous solution.

47. The reactor of any one of claims 42-46, wherein the mixer comprises an impeller.

48. The reactor of any one of claims 42-47, wherein the magnetic field source is positioned proximate an outlet of the vessel.

49. The reactor of any one of claims 42-48, wherein the magnetic field source comprises a magnetic filter, such as a magnetic cage.

50. A method comprising:
carrying out, in a vessel, a chemical reaction in which a product of the chemical reaction has a greater magnetic susceptibility than a reactant of the chemical reaction; and
simultaneously effecting, in the vessel, a separation between the product and the reactant with a magnetic field source.

51. The method of claim 50, wherein the chemical reaction is carried out in a liquid.

52. The method of claim 51, wherein the liquid comprises an aqueous solution.

53. The method of any one of claims 50-52, wherein the reactant is hematite and the product is magnetite.

54. The method of any one of claims 50-53, further comprising flowing a liquid comprising the reactant into the vessel through an inlet of the vessel.

55. The method of any one of claims 50-54, further comprising retrieving the product from the magnetic field source by flowing a liquid comprising the product through the magnetic field source and out of the vessel through an outlet of the vessel.

56. The method of any one of claims 50-55, wherein the chemical reaction is carried out at a temperature of greater than or equal to 60 degrees Celsius and less than or equal to 500 degrees Celsius.

57. The method of claim 56, wherein the chemical reaction is carried out at a temperature of greater than or equal to 200 degrees Celsius and less than or equal to 400 degrees Celsius.

58. The method of any one of claims 51-57, wherein carrying out the chemical reaction comprises stirring the liquid.

59. The method of claim 58, wherein stirring the liquid comprises rotating an impeller in the vessel.
